(19) United States
(12) Patent Application Publication
(10) Pub. No.: US 2026/0281014 A1
(43) Pub. Date: Sep. 17, 2026

(54) SYSTEM

(71) Applicant: SoftBank Group Corp., Tokyo (JP)

(72) Inventor: Tomoaki YONEYAMA, Tokyo (JP)

(73) Assignee: SoftBank Group Corp., Tokyo (JP)

(21) Appl. No.: 19/551,638

(22) Filed: Feb. 27, 2026

Related U.S. Application Data
(60) Provisional application No. 63/770,755, filed on Mar. 12, 2025.

(51) Int. Cl. H04L 43/04; G06F 18/21; G06F 18/2113; G06N 3/045; G06N 3/0475; H04L 41/0631

(52) U.S. Cl. CPC H04L 43/04; G06F 18/2113; G06F 18/217; G06N 3/045; G06N 3/0475; H04L 41/0631

(57) ABSTRACT

A system includes a processor that is configured to record past failure response histories in a history recording unit, collect syslog messages output from network devices in a log collection unit, refer to manufacturer manuals in a manual reference unit, and use data from the history recording unit, the log collection unit, and the manual reference unit in an analysis unit including a generative artificial intelligence model to identify a cause of a failure and to propose a countermeasure for the failure.

### CROSS-REFERENCE TO RELATED APPLICATION

This application claims the benefit of U.S. Provisional Application No. 63/770,755, filed on Mar. 12, 2025, pursuant to 35 U.S.C. § 119(e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional network operation and maintenance systems rely heavily on manual log analysis and fragmented information sources when dealing with failures in network devices. In many environments, technicians must individually collect syslog messages, consult separate manufacturer manuals, and search through unstructured or poorly indexed past incident records. As a result, identification of the root cause of a failure often takes a long time, depends strongly on the experience of specific individuals, and may lead to inconsistent or sub-optimal countermeasures. Furthermore, existing systems typically do not leverage accumulated failure response histories in a structured way, do not perform real-time correlation between current syslog data and past cases, and do not provide unified, natural-language guidance tailored to technicians at the time of failure. Consequently, there is a need for a system that can automatically collect and analyze syslog messages, systematically utilize past failure response histories and manufacturer manuals, and promptly generate accurate, technician-oriented proposals for failure causes and countermeasures, thereby improving the speed, accuracy, and consistency of failure handling in network devices.

### SUMMARY

In order to solve the above problems, the present invention provides a system comprising a processor configured to functionally implement multiple cooperating units. The processor is configured to record past failure response histories in a history recording unit, to collect syslog messages output from network devices in a log collection unit, and to refer to manufacturer manuals in a manual reference unit. The processor is further configured to use data from the history recording unit, the log collection unit, and the manual reference unit in an analysis unit including a generative artificial intelligence model, to identify causes of failures and to propose countermeasures for the failures. In some embodiments, the processor is configured to analyze the past failure response histories in a learning unit, to learn patterns of failures based on the analysis, and to analyze, in real time, syslog messages output from the network devices at a time of a failure. The processor is configured to identify a cause of the failure by comparing the real-time syslog messages with the past failure response histories, to refer to the manufacturer manuals, and to propose, in natural language, an optimal countermeasure based on the manufacturer manuals. In other embodiments, the processor is configured to analyze error messages in the syslog messages by using natural language processing techniques in the analysis unit, to detect signs of failures based on analysis results, and to generate, by referring to the past failure response histories and the manufacturer manuals, proposals functioning as guides for technicians to repair the failures quickly and accurately.

The term “processor” refers to one or more hardware processing circuits, such as a central processing unit (CPU), a microprocessor, a digital signal processor, or a combination thereof, configured to execute instructions for implementing the functions of the system.

The term “history recording unit” refers to a functional unit, implemented by the processor and associated storage, that records and stores structured data representing past failure response histories, including information such as failure events, causes, countermeasures, results, and timestamps.

The term “failure response history” refers to stored information describing at least one past failure event of a network device and a corresponding response, including at least one of a cause of the failure, an action taken, a resolution result, and a time required for repair.

The term “log collection unit” refers to a functional unit, implemented by the processor and communication interfaces, that receives, collects, and optionally normalizes syslog messages or similar log data output from network devices.

The term “syslog message” refers to a log message generated by a network device in accordance with a syslog protocol or a compatible logging scheme, including at least a timestamp and a message body that may contain error messages related to failures.

The term “network device” refers to any device capable of transmitting, receiving, or forwarding data in a communication network, including but not limited to routers, switches, firewalls, servers, and wireless access points.

The term “manual reference unit” refers to a functional unit, implemented by the processor and storage or external databases, that accesses, indexes, and searches digital versions of manufacturer manuals to obtain information related to failure causes and countermeasures.

The term “manufacturer manual” refers to documentation provided by a device manufacturer, including at least one of installation guides, operation manuals, troubleshooting guides, and error code references, describing the specifications and recommended procedures for the network device.

The term “analysis unit” refers to a functional unit, implemented by the processor, that processes data from the history recording unit, the log collection unit, and the manual reference unit to identify failure causes and propose countermeasures, and that includes or cooperates with a generative artificial intelligence model.

The term “generative artificial intelligence model” refers to a machine learning model capable of generating new content, including natural-language text, based on input data such as syslog messages, failure histories, and manual excerpts, and configured to output proposed causes and countermeasures.

The term “learning unit” refers to a functional unit, implemented by the processor, that performs analysis of past failure response histories to extract patterns of failures and to update one or more models or rules used for classification, prediction, or suggestion.

The term “natural language processing techniques” refers to algorithms and models used by the processor to interpret, classify, or otherwise analyze text data expressed in human language, such as error messages contained in syslog messages.

The term “failure cause” refers to an identified or inferred underlying reason for a malfunction of a network device, including but not limited to hardware defects, configuration errors, software bugs, and abnormal traffic conditions.

The term “countermeasure” refers to a recommended action or set of actions intended to mitigate, correct, or prevent a failure in a network device, including but not limited to configuration changes, hardware replacement, software updates, and traffic control.

The term “proposal” refers to a generated output, typically in natural language, that presents at least one of an estimated failure cause, a step-by-step countermeasure procedure, and associated cautions or risks, and that is intended to guide a technician in repairing a failure. The term “technician” refers to a person responsible for operating, maintaining, or troubleshooting network devices, and who uses the proposals generated by the system as guidance for failure repair.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

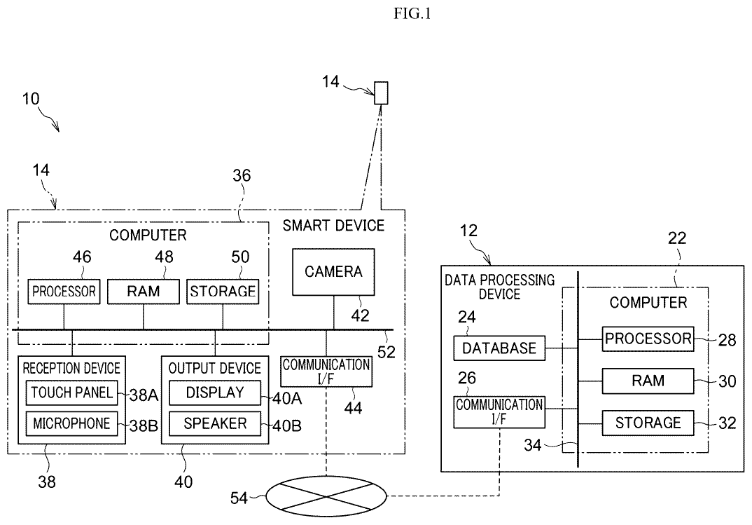

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

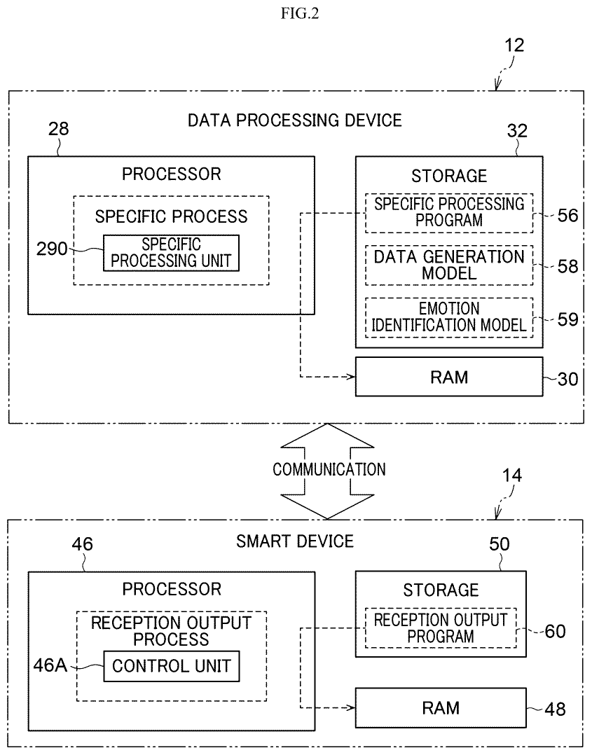

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional failure-handling support systems for communication equipment and other information processing apparatuses typically rely on static rule sets, manually curated knowledge bases, or simple keyword-based retrieval of log messages and technical documents. Such systems suffer from several technical limitations.

First, conventional systems are not capable of effectively integrating heterogeneous machine-generated data, such as time-series operation monitoring information, unstructured log messages, and semi-structured technical documentation, into a unified representation suitable for automated analysis. As a result, the processor must execute multiple disjoint processing pipelines, causing redundant memory transfers, inefficient indexing, and increased latency in identifying and classifying failure events.

Second, existing approaches lack a closed feedback loop between actual failure-handling outcomes and the underlying analytical models. While some systems record historical incidents, they do not systematically use user feedback regarding which steps were effective or ineffective to update classification logic or natural-language guidance generation. Consequently, the processor cannot improve its failure classification accuracy or its recommendation quality over time, and the system continues to generate suboptimal or overly generic guidance, which degrades system reliability and wastes computational resources.

Third, when large-scale generative AI models are used in a naive manner, the models are often prompted with incomplete or poorly structured context. This leads to responses that are verbose, inconsistent with device-specific technical documents, or not aligned with historically successful actions. Such behavior forces the processor or the user to perform additional filtering, thereby increasing processing load and response time. Furthermore, without a structured mechanism to generate instruction sentences (prompts) that explicitly encode incident context, historical similarity, and authoritative technical documentation, the generative AI model cannot be reliably integrated into a real-time failure-handling workflow.

Fourth, user interfaces in conventional systems frequently present logs, historical records, and AI outputs as separate, loosely connected views. This fragmented presentation forces a user to manually correlate information, which increases cognitive load and introduces operator error. In addition, since the system does not capture effectiveness evaluation information per step of an AI-generated procedure, it cannot associate fine-grained user feedback with specific parts of the analytical pipeline or generative output, thus limiting the ability of the processor to optimize internal data structures, model parameters, and prompt generation rules.

Accordingly, there is a need for a technical mechanism that allows a processor to: (i) unify and structure heterogeneous monitoring information, historical incident data, and technical documents; (ii) perform machine learning-based classification and similarity computation to identify relevant past cases and authoritative documentation; (iii) automatically construct instruction sentences (prompt sentences) that encode integrated context for a generative AI model; (iv) structure and persist the generated stepwise countermeasure procedure information; and (v) capture and use step-level effectiveness feedback to update both discriminative models and generative prompt generation conditions. By solving these problems, the processor can reduce processing latency, improve classification and recommendation accuracy, and enhance the overall robustness and efficiency of computer-based failure-handling support.

The specific processing by the specific processing unit 290 of the data processing device 12 in Example 1 is realized by the following means.

The present invention provides a server comprising a processor configured to store and search past failure-handling information as structured data in a history information recording unit; receive operation monitoring information transmitted from an information processing apparatus, convert the operation monitoring information into unified-format data, and store the unified-format data in an operation information collection unit; store technical document information as indexable data enabling full-text search and extract related technical information in a reference information search unit; classify a failure event and estimate one or more candidate causes of the failure event based on the operation monitoring information and the history information in a machine learning processing unit; generate an instruction sentence to be input to a generative AI model based on the candidate causes and the technical document information acquired from the reference information search unit, input the instruction sentence to the generative AI model, acquire countermeasure procedure information expressed in natural language from the generative AI model, and structure and store the countermeasure procedure information in an analysis unit; present summary information of the failure event and the countermeasure procedure information to a user terminal, acquire evaluation information regarding execution results of the countermeasure procedure information, and register the evaluation information in the history information recording unit in a user interface unit; and update training data of the machine learning processing unit and update generation conditions of the instruction sentence to be input to the generative AI model based on the acquired evaluation information in a learning control unit. This enables the processor to unify heterogeneous monitoring and documentation data, generate context-rich prompt sentences, obtain and structure stepwise countermeasure procedures from the generative AI model, and iteratively refine both discriminative and generative behavior based on real-world feedback, thereby improving the technical performance, responsiveness, and reliability of computer-implemented failure-handling support.

The term “history information recording unit” refers to a functional unit implemented by a processor and memory that stores, indexes, and retrieves past failure-handling information as structured data, including information about failure events, causes, countermeasures, and outcomes.

The term “operation information collection unit” refers to a functional unit implemented by a processor and memory that receives operation monitoring information from one or more information processing apparatuses, converts the information into a unified data format, and stores the converted information for subsequent analysis.

The term “reference information search unit” refers to a functional unit implemented by a processor and memory that stores technical document information in a searchable form, maintains index data enabling full-text or semantic search, and extracts technical information relevant to a given query or incident context.

The term “machine learning processing unit” refers to a functional unit implemented by a processor executing a trained machine learning model that generates feature information from operation monitoring information and history information, and classifies failure events or estimates one or more candidate causes based on the generated feature information.

The term “analysis unit” refers to a functional unit implemented by a processor and memory that generates an instruction sentence for a generative AI model based on candidate causes and technical document information, transmits the instruction sentence to the generative AI model, receives countermeasure procedure information expressed in natural language from the generative AI model, and structures and stores the countermeasure procedure information.

The term “user interface unit” refers to a functional unit implemented by a processor, memory, and display control circuitry that presents summary information of a failure event and corresponding countermeasure procedure information to a user terminal, receives evaluation information regarding execution results from a user, and registers the evaluation information in the history information recording unit.

The term “learning control unit” refers to a functional unit implemented by a processor and memory that controls updating of training data used by the machine learning processing unit and updating of generation conditions for instruction sentences to be input to a generative AI model, based on evaluation information acquired from the user interface unit.

The term “operation monitoring information” refers to machine-generated data indicating operational states of an information processing apparatus, including but not limited to log messages, status messages, and time-series measurements of performance or error conditions.

The term “technical document information” refers to information contained in documentation related to information processing apparatuses, including manuals, specifications, troubleshooting guides, and other reference materials, which describe error codes, configurations, procedures, and precautions.

The term “failure event” refers to an event or condition in an information processing apparatus or communication equipment that is indicative of a malfunction, abnormal state, or performance degradation, detected based on operation monitoring information.

The term “candidate cause” refers to a hypothesized cause or root-cause category associated with a failure event, estimated by the machine learning processing unit using operation monitoring information and history information.

The term “instruction sentence” refers to a text sequence generated by the analysis unit that encodes context about a failure event, history information, and technical document information, and is formatted as an input prompt for a generative AI model to produce countermeasure procedure information.

The term “generative AI model” refers to an information processing model, such as a large language model, that generates natural-language text outputs in response to text inputs, and is used to produce countermeasure procedure information based on an instruction sentence.

The term “countermeasure procedure information” refers to information describing one or more actions, steps, or procedures to be executed in order to diagnose, mitigate, or resolve a failure event, the information being generated or refined by the generative AI model.

The term “evaluation information” refers to information provided by a user indicating effectiveness or ineffectiveness of one or more countermeasure steps, execution results, actual causes, or other feedback associated with handling a failure event.

The term “feature information” refers to numerical or symbolic values generated from operation monitoring information and history information, including time-series patterns and message content features, which are used as input to the machine learning processing unit for classification or estimation.

The term “similarity” refers to a numerical measure indicating a degree of resemblance between a current failure event and one or more past failure events stored in the history information recording unit, calculated based on feature information or other attributes.

The term “instruction sentence generation conditions” refers to parameters, rules, or templates that determine how the analysis unit constructs an instruction sentence, including selection and ordering of context elements, level of detail, and constraints provided to the generative AI model.

The term “user terminal” refers to an information processing device, such as a personal computer, a tablet, or a smartphone, that communicates with the server, presents information to a user, and transmits user input including evaluation information to the server.

The term “proposal” refers to a natural-language description generated by the generative AI model that includes stepwise countermeasure procedure information and optional risk information intended to guide a user in handling a failure event.

In one embodiment, a server, a terminal, and a user cooperate to implement a failure-handling support system as defined in the claims. The server includes one or more processors, a main memory, a non-volatile storage device, and a network interface. The terminal includes a processor, a memory, a display device, an input device, and a communication interface. The user operates the terminal to view failure information, execute countermeasures on communication equipment or other information processing apparatuses, and provide feedback.

The server executes a program stored in the non-volatile storage device and loaded into the main memory. The server program is implemented, for example, on a general-purpose computer running an operating system such as a server-class operating system. The server uses a relational database management system such as a relational database, and a search engine such as a full-text search engine. The server further uses a machine learning framework such as a deep learning framework, and a natural language processing library.

The server provides a history information recording unit by using the relational database. The server defines database tables for incidents, actions, failure categories, devices, and user feedback. The server stores past failure-handling information as structured records. For example, the server stores, as a row in an incident table, fields including an incident identifier, a device identifier, a main error code, a failure category, a start time, an end time, a resolution status, and a reference to recommended procedure steps. The server uses index structures such as B-tree indexes on columns including the device identifier, the error code, and the failure category. The server thereby reduces query time and improves throughput when retrieving similar past incidents.

The server provides an operation information collection unit by receiving operation monitoring information, such as syslog messages, SNMP traps, or other event messages, from communication equipment or information processing devices via the network interface. The server uses a logging subsystem such as a syslog daemon to receive log messages over a specified port, attach a precise reception timestamp, and write the messages into an append-only storage or a message queue. The server then parses the raw text into a normalized internal structure. The server converts each message into a record containing a timestamp, a source identifier, a severity level, a facility code, an error code, and a message body. The server stores the normalized records in a time-series index or a document index in the search engine. This specific data structure allows the server to perform efficient time-range and keyword-based retrieval, which reduces I/O overhead and CPU time during incident analysis.

The server provides a reference information search unit by storing technical document information, such as equipment manuals, configuration guides, and troubleshooting documents, in the search engine. The server converts documents from formats such as PDF or HTML into plain text using a document conversion tool. The server segments the text into sections and assigns metadata fields including device model, document type, and topic keywords. The server generates an inverted index that maps terms and phrases to document sections. The server optionally generates vector embeddings for each section using a sentence embedding model. The server stores these embeddings in a vector index. This combination of inverted index and vector index allows the server to return relevant document sections quickly with both lexical and semantic similarity, thereby improving retrieval precision and reducing the number of documents that need to be scanned in subsequent processing.

The server provides a machine learning processing unit using a trained model executed by the processor. In one embodiment, the server implements a multi-layer neural network classifier. The server uses a text encoder, such as a transformer-based encoder, to convert message text into a fixed-dimensional embedding vector. The server combines this embedding with numerical features such as error frequency in a time window, the number of affected interfaces, and the distribution of severity levels. The server provides this combined feature vector as input to the classifier. The classifier has multiple fully connected layers with activation functions, such as rectified linear units, and a softmax output layer over predefined failure categories, including but not limited to hardware failure, configuration error, link issue, and authentication problem. The server trains this classifier using supervised learning, with cross-entropy as a loss function and gradient-based optimization such as stochastic gradient descent or an adaptive optimizer. The server uses labeled examples from past incidents, where each example includes a set of log messages and a ground-truth failure category. The server may perform data augmentation by sampling different time windows or by masking non-essential tokens in the log text. As a result of this architecture, the server can classify new failure events with higher accuracy and lower inference latency than rule-based systems, thereby improving technical performance in incident triage.

The server provides an analysis unit that generates an instruction sentence (prompt sentence) for a generative AI model. The server first aggregates context information. The server retrieves a summary of the current failure event from the operation information collection unit and the machine learning processing unit, including the most frequent error codes, the predicted failure category, and a representative set of log messages. The server retrieves similar past incidents from the history information recording unit by computing a similarity metric between the current feature vector and historical feature vectors. The server selects past incidents with similarity above a threshold and extracts their successful countermeasure steps. The server retrieves relevant technical document sections from the reference information search unit based on the device model and error code. The server then constructs a structured internal representation that includes: (i) event metadata; (ii) a list of representative log messages; (iii) a list of past countermeasures; and (iv) a list of key manual recommendations.

The server converts this structured internal representation into a text instruction sentence according to a prompt template. The server, for example, generates an instruction sentence as follows:

“Network device A (model X1000) has generated multiple syslog messages with error code 123 during the last 15 minutes. The logs indicate repeated ‘interface down’ and ‘link state change’ events on port Gi0/1. A trained classifier categorized this incident as a ‘link_issue’ with high confidence. Past incidents with error code 123 on the same model were successfully resolved by replacing the SFP module or verifying fiber cabling. The vendor manual describes error code 123 as ‘SFP module failure’ and recommends checking the LINK LED, replacing the SFP, and verifying optical power levels. Based on this information, generate a concise, numbered list of troubleshooting steps for a network engineer. Mention risks and recommended verification commands.”

The server thereby generates a context-rich prompt that encodes both symbolic and statistical reasoning results. This is not merely a textual restatement of logs; rather, it is a synthesized representation that constrains the generative model toward device-specific and historically validated procedures. The server transmits this instruction sentence to a generative AI model endpoint via a network request. The server sets parameters such as temperature, maximum output length, and required output structure. The generative AI model, for example, is implemented as a large language model with a transformer architecture consisting of multiple attention layers and feed-forward layers, trained on a large corpus of technical and general text.

The server receives a natural language response from the generative AI model. The server parses the response by detecting numbered lines, bullet markers, or step headings. The server normalizes each step into a structured record containing fields such as step number, action description, required conditions, and caution notes. The server, in the analysis unit, cross-checks each step against the reference information search unit and the history information recording unit. For example, the server checks whether the step refers to commands or component names present in the manual, and whether similar steps appeared in successful past incidents. The server assigns a confidence score or a trust level to each step based on this cross-check. As a result, the server filters or annotates generative output, thereby reducing the risk of hallucinated or incompatible instructions and improving safety and reliability beyond what a user operating the model would obtain without such structuring.

The server provides a user interface unit that delivers the analyzed information to the terminal. The server exposes an application programming interface that returns, in response to a request from the terminal, data including the event summary, the predicted category, the structured list of countermeasure steps, and references to technical document sections. The terminal renders this information on the display device in a human-readable form. The terminal displays each step with an interactive control, such as a checkbox or button, enabling the user to indicate execution and effectiveness. The terminal may further display graphs of error counts over time or status indicators, based on data provided by the server. The user confirms which steps have been performed, enters additional notes such as observed root cause, and marks each step as effective, ineffective, or not executed.

The server receives the feedback as evaluation information via the user interface unit. The server stores the evaluation information in the history information recording unit with associations to the incident and to the relevant steps. The server thus obtains fine-grained labels at the step level rather than only at the whole-incident level. The server uses this data to update both the machine learning processing unit and the prompt generation logic in the analysis unit.

The server provides a learning control unit that orchestrates these updates. The server periodically constructs training batches from the accumulated history and evaluation data. For the classifier in the machine learning processing unit, the server updates the model weights by computing a loss function comparing predicted categories with refined categories derived from successful steps and user comments. The server may adjust the neural network parameters using mini-batch gradient descent and adjust learning rates. For the generative prompt logic, the server analyzes correlations between prompt patterns and step effectiveness. The server can, for example, empirically determine that including certain manual excerpts or emphasizing specific device states yields higher success rates. The server then updates the prompt template or weighting rules used to select contextual elements. In this manner, the server adapts internal data structures, such as feature encodings and template parameters, and not merely content, thereby improving computational efficiency and accuracy in subsequent incidents.

The server achieves technical improvements by several mechanisms. First, the server uses a dedicated feature representation that combines semantic embeddings of log messages with structured numerical attributes, enabling more accurate and more efficient classification than either rule-based parsing or simple keyword matching. This reduces unnecessary database lookups and decreases the number of candidate incidents to be examined, thus improving processing speed and reducing CPU usage. Second, the server uses an integrated data flow that connects the history information recording unit, the reference information search unit, and the machine learning processing unit through well-defined intermediate data structures. This architecture reduces redundant parsing and serialization operations and improves cache locality, which enhances throughput when processing large log volumes.

Third, the server uses a structured prompt generation process that creates instruction sentences incorporating machine-derived similarity measures and authoritative documentation. This differs from manual prompt engineering or naive concatenation of logs. By operating according to formal templates and quantitative thresholds, the server reduces the variance and error rate of the generative AI model output. Fourth, the server leverages step-level evaluation information to adjust both discriminative models and prompt-generation rules. Because the server uses a fine-grained mapping between steps and outcomes, it can reweigh feature importance or revise templates to eliminate consistently ineffective actions, thereby reducing repeated irrelevant processing and network traffic associated with unnecessary model calls.

The terminal provides an interface that enables the user to interact with the server in a technical manner. The terminal programs a browser or a native application to render dynamically updated views based on data received from the server. The terminal may implement local caching or incremental updates to reduce communication load. The terminal can, for example, only request delta updates of incident state from the server, which lowers bandwidth consumption on the network interface. The user, by operating the terminal, can apply the suggested steps to actual equipment, such as sending configuration commands via a secure management channel. The system thereby couples logical analysis with concrete control of physical or virtual devices, leading to measurable reductions in downtime.

The user benefits from the system because the user no longer has to manually search large log files or technical documents. The user can rely on a set of recommendations that have been filtered and ranked by technical consistency and past success. However, the invention does not merely automate human reading. The server conducts operations that are not readily feasible for human operators, such as computing high-dimensional similarities between thousands of incidents, maintaining complex indexes over millions of log records, and retraining neural network models on large datasets. These activities change the internal operation of the computer system itself, yielding improved data structures, better model parameters, reduced execution time, and lower memory consumption.

In alternative embodiments, the server may use different architectures while maintaining the same functional units. The server may replace a transformer-based encoder with a convolutional network or a recurrent network, or may use a gradient-boosted tree model for classification. The server may use different similarity metrics, such as cosine similarity on embeddings, Euclidean distance on numerical features, or a learned metric. The server may choose to store history information in a column-oriented database instead of a row-oriented database, or may employ a message queue for decoupling log reception from analysis. The reference information search unit may employ different ranking algorithms, such as BM25 or neural ranking, or may include language-specific tokenization schemes. The generative AI model may run on a local accelerator or may be hosted as an external service, as long as the server continues to generate structured instruction sentences and to post-process responses according to the claimed functions.

The server, the terminal, and the user thus realize an embodiment of the invention in which generative AI model outputs are integrated with structured failure data and technical document knowledge, in a closed-loop architecture that continuously improves the internal technical behavior of the computing system, including processing speed, classification accuracy, storage efficiency, and communication load, rather than merely automating an existing business procedure.

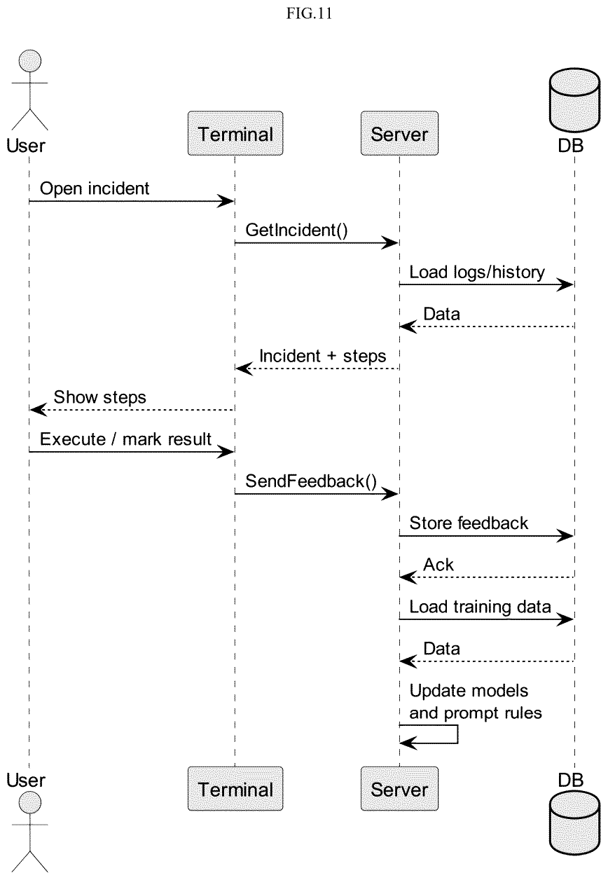

The following describes the processing flow using FIG. 11.

### Step 1:

Server receives raw operation monitoring information from information processing apparatuses and communication equipment.

Server takes, as input, network packets carrying syslog messages, trap messages, or other log records.

Server parses each packet, extracts a timestamp, a source identifier, a severity level, and a message body, and writes the parsed data into a temporary log buffer in memory.

Server appends each parsed log as a structured record into a persistent log storage or message queue, adding internal fields such as a reception sequence number and a normalized time format.

Server outputs a stream of normalized log records ready for further processing.

### Step 2:

Server normalizes log records and stores them in an indexed storage structure.

Server takes, as input, the stream of normalized log records from Step 1.

Server converts each record into a canonical internal schema containing fields such as device_id, facility_code, error_code, message_text, and event_time.

Server performs data cleaning operations, including removing duplicate records, correcting malformed timestamps, and mapping raw device names to canonical device identifiers.

Server inserts the cleaned records into a time-series index and a document index in a search engine, updating inverted indexes and time-based partitions.

Server outputs indexed log documents that can be efficiently retrieved by device_id, time range, or keyword.

### Step 3:

Server detects candidate failure events and groups related log records.

Server takes, as input, indexed log documents from Step 2 and monitoring parameters such as threshold values and time windows.

Server scans logs for patterns such as a burst of error-level messages, repeated occurrences of a specific error_code, or simultaneous warnings from multiple components of the same device.

Server computes event metrics, including error count per time window and variance of severity, and compares these metrics with predefined thresholds.

Server, when a threshold is exceeded, assigns a new incident_id and groups the related logs into an incident cluster, linking each log record to that incident_id.

Server outputs incident clusters, each including a set of associated log records and basic incident metadata.

### Step 4:

Server generates feature information for each incident cluster.

Server takes, as input, an incident cluster from Step 3 and its associated log records.

Server extracts textual features by tokenizing message_text fields, removing stop words, and encoding the tokens into embedding vectors using a language model encoder.

Server extracts numerical features such as error frequency, distribution of severity, number of affected interfaces, and duration of the event.

Server concatenates textual and numerical features into a single feature vector for each incident and standardizes numeric components using stored mean and variance parameters.

Server outputs a feature vector representing the incident in a high-dimensional feature space.

### Step 5:

Server classifies the type and priority of the failure event.

Server takes, as input, the feature vector from Step 4.

Server loads a trained classification model into memory and feeds the feature vector into the model.

Server computes internal activations through layers of the neural network and produces probability values over predefined failure categories and priority levels.

Server selects the category with the highest probability as the predicted failure type, and derives a priority level based on probability distribution and configured rules.

Server stores the predicted category and priority in an incident record and outputs an enriched incident description including these predictions.

### Step 6:

Server searches history information to find similar past incidents.

Server takes, as input, the feature vector and enriched incident description from Step 5.

Server queries the history information recording unit using conditions such as device_id, error_code, and failure category, and retrieves a set of candidate historical incidents.

Server computes similarity scores between the current feature vector and feature vectors of candidate incidents using a similarity function such as cosine similarity.

Server sorts the candidates by similarity score and selects top matches whose score exceeds a preset threshold.

Server outputs a list of similar past incidents, each with associated countermeasure steps and outcome labels (successful or unsuccessful).

### Step 7:

Server retrieves relevant technical document sections corresponding to the incident.

Server takes, as input, the enriched incident description from Step 5 and device metadata from the operation information collection unit.

Server constructs a document query by combining device model identifiers, main error codes, and key terms extracted from message_text.

Server submits the query to the reference information search unit, which searches full-text and vector indexes and returns ranked document sections.

Server optionally re-ranks the results by computing semantic similarity between incident feature vectors and section embeddings.

Server selects a subset of the most relevant sections and outputs these sections as technical document snippets associated with the incident.

### Step 8:

Server aggregates contextual information for prompt construction.

Server takes, as input, the enriched incident description from Step 5, the list of similar incidents from Step 6, and the technical document snippets from Step 7.

Server extracts representative log messages with highest severity or closest proximity to the incident start time.

Server summarizes successful countermeasure sequences from similar incidents and filters out steps associated only with unsuccessful outcomes.

Server identifies key recommendations and warnings from the technical document snippets and reduces them to concise statements.

Server combines these elements into a structured context object representing the incident, historical patterns, and authoritative guidelines.

Server outputs the structured context object as input for prompt generation.

### Step 9:

Server generates a prompt sentence for a generative AI model.

Server takes, as input, the structured context object from Step 8 and one or more prompt templates stored in the analysis unit.

Server fills template placeholders with specific values, including device identifiers, error codes, predicted failure categories, excerpted log messages, summaries of past successful actions, and manual recommendations.

Server assembles a coherent, readable instruction sentence that explicitly requests stepwise troubleshooting advice and risk information.

Server verifies that the prompt length and structure satisfy configured constraints, such as maximum character count and required sections.

Server outputs the final prompt sentence to be sent to the generative AI model.

### Step 10:

Server requests countermeasure procedure information from the generative AI model.

Server takes, as input, the prompt sentence from Step 9.

Server creates an API request message including the prompt sentence and model parameters such as temperature and maximum tokens.

Server transmits the request to a generative AI model endpoint and waits for a response.

Server receives a natural language response containing proposed troubleshooting steps and additional explanatory text.

Server outputs the raw generative AI response as textual procedure information.

### Step 11:

Server parses and structures the generative AI response.

Server takes, as input, the raw textual procedure information from Step 10.

Server identifies step boundaries by detecting numbering patterns, bullet symbols, or step header keywords in the text.

Server splits the text into individual step segments and extracts a concise action description, any mentioned commands, and associated risk or caution statements for each segment.

Server stores these elements in a structured format, such as a list of step records, and assigns an internal identifier and execution order to each step.

Server outputs a structured procedure list ready to be cross-checked against history and manuals.

### Step 12:

Server validates and annotates the structured procedure list.

Server takes, as input, the structured procedure list from Step 11, the similar past incidents from Step 6, and the technical document snippets from Step 7.

Server compares each step with known successful steps in past incidents by matching command patterns, operation types, and affected components.

Server checks consistency between each step and technical document instructions, flagging any action that conflicts with or is absent from the reference documents.

Server assigns a confidence score and a trust label to each step based on historical success rate and documentation support.

Server stores the annotated procedure list in the history information recording unit and outputs an enriched procedure list with confidence and trust metadata.

### Step 13:

Server prepares data for presentation to the terminal.

Server takes, as input, the enriched incident description from Step 5 and the annotated procedure list from Step 12.

Server constructs a response object containing incident metadata, predicted failure type and priority, representative log samples, the ordered list of steps with confidence scores, and links to relevant technical document sections.

Server serializes the response object into a format suitable for transmission, such as a structured payload, while ensuring that sensitive identifiers are masked if required.

Server caches the response for quick access in case of repeated requests from the same terminal.

Server outputs the response object to be sent to the terminal.

### Step 14:

Terminal requests and displays incident and procedure information.

Terminal takes, as input, a user selection of an incident identifier or a notification received from the server.

Terminal sends a request to the server for detailed incident information and waits for the response object from Step 13.

Terminal receives the response and parses the incident metadata, procedure steps, and document links.

Terminal renders a graphical user interface that displays a high-level summary of the incident, a timeline of key log events, and the annotated list of troubleshooting steps with visual indicators for confidence and trust.

Terminal outputs a visual representation that allows the user to read and interact with the recommended procedure.

### Step 15:

User reviews recommendations and executes actions on equipment.

User takes, as input, the information displayed on the terminal from Step 14.

User reads the incident summary and each recommended step, paying particular attention to high-confidence and documentation-supported actions.

User decides which steps to execute, possibly following the suggested order, and performs concrete operations on communication equipment or information processing apparatuses, such as issuing configuration commands, replacing components, or restarting services.

User observes the system behavior and error messages after each action to determine intermediate results.

User outputs an internal judgment about the effectiveness and safety of each executed step.

### Step 16:

User provides feedback on executed steps.

User takes, as input, the observed results of the executed actions and the step list displayed on the terminal.

User marks each step on the terminal interface as effective, ineffective, or not executed, and optionally enters comments describing the actual root cause and any additional measures taken.

User submits the feedback through the terminal, which packages the evaluation data, including incident_id, step identifiers, effectiveness labels, and comments.

Terminal transmits the evaluation data to the server via a communication interface.

Terminal outputs a confirmation view indicating that the feedback has been sent.

### Step 17:

Server records feedback and updates history.

Server takes, as input, the evaluation data received from the terminal in Step 16.

Server associates each feedback item with the corresponding incident record and step record in the history information recording unit.

Server updates outcome fields such as final status, resolution time, and actual cause, and increments counters tracking success rates of individual step types.

Server stores the updated records and indexes new feedback fields to enable later retrieval and analysis.

Server outputs an updated history dataset that incorporates real-world effectiveness information.

### Step 18:

Server prepares training data for model and prompt improvement.

Server takes, as input, the updated history dataset from Step 17.

Server selects incidents with complete feedback, extracting pairs of incident features and final confirmed categories for classifier training, and pairs of prompts and effective step sequences for prompt analysis.

Server constructs training samples by aggregating features, labels, and contextual attributes, and applies preprocessing such as feature normalization and token formatting.

Server stores the training samples in dedicated training data tables or files, partitioned by model type and training period.

Server outputs curated training datasets ready for use in model updating.

### Step 19:

Server updates machine learning model parameters based on feedback.

Server takes, as input, the classifier training dataset from Step 18.

Server loads the current classifier model and computes predicted categories for each training sample, then compares these predictions with confirmed categories to compute a loss value using an error function.

Server computes gradients of the loss with respect to model parameters and updates the parameters using an optimization algorithm, iterating over mini-batches until convergence or until a stopping criterion is satisfied.

Server evaluates the updated model on a validation subset and, if accuracy and stability criteria are met, deploys the new model to the machine learning processing unit.

Server outputs revised classifier parameters that improve category prediction and priority estimation for future incidents.

### Step 20:

Server refines prompt generation conditions using step-level effectiveness data.

Server takes, as input, the prompt and step effectiveness dataset from Step 18.

Server analyzes patterns such as which context elements (e.g., specific manual citations, similarity statistics, or log excerpts) appear in prompts that lead to high success rates.

Server adjusts prompt generation parameters, including selection thresholds for historical incidents, emphasis weights for technical document snippets, and wording templates for instructions and constraints.

Server may construct or update a scoring function that ranks potential context elements by their historical impact on step effectiveness and uses this function when assembling new prompts.

Server stores updated prompt templates and scoring parameters in the analysis unit and marks old versions as inactive.

Server outputs improved prompt generation conditions that guide the generative AI model toward more accurate, concise, and safe countermeasure procedure information for subsequent incidents.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional data-center and network-operation support systems generally rely on static rule engines, fixed threshold alerts, and manually maintained runbooks. In these systems, log messages and operational metrics from information processing apparatuses and communication apparatuses are collected and displayed, but the transformation of such heterogeneous operational information into actionable, context-aware guidance is largely performed by human operators. As a result, the following technical problems arise.

First, conventional systems are limited in their ability to synthesize large volumes of unstructured log data, structured metrics, historical failure-response records, and technical reference information into a unified incident representation that can be processed automatically. Log messages are often treated as simple text or pattern-matching targets, and historical incident databases are used only for keyword search. This leads to inefficient use of the underlying computing resources, because the processor must repeatedly perform ad hoc searches and manual correlation operations, which increases latency in incident diagnosis and consumes unnecessary computing cycles.

Second, even when machine-learning techniques are introduced for anomaly detection or classification, the interaction between such models and any generative artificial intelligence model is not structurally integrated. Conventional approaches either use generative models in a standalone manner, or they inject raw logs or minimal summaries as prompts. In such cases, the prompt sentences are not optimized according to historical effectiveness of proposed countermeasures; the generative model is not constrained by explicit safety and formatting conditions derived from system policies; and the model's output is not systematically mapped to executable processing targets in the managed computing infrastructure. This results in unstable quality of generated countermeasures, difficulty in automating remediation actions, and increased burden on operators to filter and adapt the generated text manually.

Third, conventional systems lack a closed feedback loop in which the actual success or failure of generated recommendations is captured at a machine level and reintegrated into both the incident-analytics logic and the prompt-construction logic for the generative model. Without such a loop, the processor cannot effectively learn which combinations of incident context, prompt elements, and proposed actions lead to successful resolution. Consequently, the system cannot improve its internal models and prompt strategies over time, and the computational resources are used repeatedly to generate low-utility or redundant recommendations, which degrades overall system performance and responsiveness.

Fourth, safety and reliability constraints are typically enforced outside the generative process, through separate review tools or human procedures. Existing systems seldom embed formal safety conditions and output-format requirements directly into the prompt sentences and into the generation pipeline. Therefore, the processor must expend additional resources to post-process, validate, and often discard portions of the generated content, which introduces latency and reduces throughput. In critical environments, this also increases the risk that unsafe instructions may be presented to operators or acted upon without sufficient filtering.

Accordingly, there is a need for a technical solution that: (i) normalizes and aggregates operational information, historical failure-response records, and technical reference information into structured incident information suitable for automatic processing; (ii) constructs optimized prompt sentences for a generative artificial intelligence model, with dynamic selection and ordering of elements based on learned effectiveness; (iii) constrains the generative model's output with safety and formatting conditions at generation time; and (iv) establishes a feedback-driven learning loop that uses actual resolution outcomes to update both incident-analysis logic and generative prompt strategies. By addressing these issues, the computing system can reduce incident diagnosis latency, improve the relevance and safety of generated countermeasures, and more efficiently utilize processor and memory resources in failure-management workflows.

The specific processing by the specific processing unit 290 of the data processing device 12 in Application Example 1 is realized by the following means.

The present invention provides a server comprising a processor configured to record historical failure-response information in a storage unit, acquire operational information output from an information processing apparatus and a communication apparatus, normalize the operational information into structured information, and store the structured information in the storage unit, refer to technical reference information stored in the storage unit, analyze the acquired and stored operational information and the recorded historical failure-response information to detect a symptom of a failure and to generate structured incident information including at least operational information related to the symptom of the failure, candidate failure causes, past cases, and response results in the past cases, generate a prompt sentence including a natural-language inquiry based on the incident information, input the prompt sentence into a generative artificial intelligence model, and cause the generative artificial intelligence model to generate proposal information in natural language regarding a failure cause and a countermeasure, convert the proposal information generated by the generative artificial intelligence model into display information, present the display information to an external apparatus, associate operation procedures included in the proposal information with executable processing targets, acquire content of processing executed based on the presented proposal information and a success or failure result of the processing, record the acquired content and result in association as a failure-response result in the storage unit, accumulate the failure-response result as learning data, use the accumulated learning data and the historical failure-response information to learn occurrence patterns of failures and effectiveness of countermeasures, update weighting in estimation of the candidate failure causes and in generation of the incident information, and dynamically change elements and an ordering of description in the prompt sentence generated for the generative artificial intelligence model based on effectiveness of past proposal information, and further add a safety condition and an output-format condition to the prompt sentence prior to generation of the proposal information and restrict response content of the generative artificial intelligence model so as to exclude, from the proposal information or output with a warning, operation instructions that violate the safety condition. This enables the server to transform heterogeneous operational information and historical data into optimized and safety-constrained prompt sentences for a generative artificial intelligence model, to obtain high-quality proposal information that can be directly mapped to executable processing in the managed computing infrastructure, and to automatically refine both incident analysis and prompt-construction behavior over time based on actual resolution outcomes, thereby improving the technical performance, reliability, and efficiency of computer-based failure management.

The term “processor” refers to a hardware execution unit, such as a central processing unit or a processing core, that executes machine-readable instructions to perform data acquisition, analysis, generation, control, and storage operations described in the present specification.

The term “storage unit” refers to a non-transitory computer-readable medium, such as a semiconductor memory, magnetic storage, or optical storage, that stores programs, configuration information, operational information, historical information, and learning data used by the processor.

The term “historical failure-response information” refers to stored data representing past failure events, detected symptoms, diagnosed causes, countermeasures taken, and results of such countermeasures, including timestamps and identifiers that allow association with specific apparatuses or services.

The term “operational information” refers to data output from an information processing apparatus or a communication apparatus, including but not limited to log messages, status messages, performance metrics, error codes, and configuration-change records that describe operational states of such apparatuses.

The term “information processing apparatus” refers to an electronic apparatus that executes software to provide computing functions, such as a server, a virtual machine, or a computing node, which outputs operational information related to its operation.

The term “communication apparatus” refers to an electronic apparatus that performs data transfer or network control, such as a network device or a communication interface device, which outputs operational information related to communication states.

The term “normalize the operational information into structured information” refers to a process in which heterogeneous operational information items are parsed, converted, and mapped into a unified data format with defined fields, such as identifiers, timestamps, categories, and numerical values, suitable for machine-based analysis.

The term “technical reference information” refers to stored data describing operational specifications, recommended procedures, constraints, or troubleshooting information related to an apparatus or a service, such as manuals, guidelines, or policy documents.

The term “symptom of a failure” refers to an observable condition derived from operational information, such as abnormal metrics, error messages, or state transitions, that indicates a possibility of a malfunction, degradation, or disruption in an apparatus or a service.

The term “structured incident information” refers to a data representation generated by the processor that combines operational information, candidate failure causes, past cases, and response results into a defined structure with identifiable fields used for further processing and decision-making.

The term “candidate failure causes” refers to one or more hypothesized reasons for a failure or abnormal condition, inferred by the processor from operational information and historical information, each optionally associated with an estimation score or confidence value.

The term “past cases” refers to previously stored instances of incidents that include at least symptoms, diagnosed causes, applied countermeasures, and outcomes, which are referenced by the processor when analyzing a current incident.

The term “response results in the past cases” refers to stored evaluations of whether countermeasures taken in the past cases were successful, partially successful, or unsuccessful, and any associated quantitative or qualitative outcome indicators.

The term “incident information” refers to structured incident information representing a particular failure-related event or condition, including its context, analysis results, and associated historical references.

The term “prompt sentence” refers to a natural-language or semi-structured text sequence constructed by the processor based on the incident information, designed for input to a generative artificial intelligence model to elicit proposal information.

The term “natural-language inquiry” refers to a portion of a prompt sentence formulated in a human language, such as English, that explicitly requests analysis, explanation, or countermeasures regarding a failure or incident.

The term “generative artificial intelligence model” refers to a machine-learning model, such as a language model, configured to generate natural-language text or other data in response to an input prompt, using learned statistical relationships from training data.

The term “proposal information” refers to one or more natural-language outputs generated by the generative artificial intelligence model, including explanations of possible causes, recommended countermeasures, and ordered operation procedures related to an incident.

The term “display information” refers to proposal information or processed forms thereof that have been transformed into a representation suitable for presentation to a human operator or an external apparatus, such as formatted text, lists, or structured data records.

The term “external apparatus” refers to any device or system, such as a user terminal or management console, that receives the display information from the server and allows a user to view or act upon the proposal information.

The term “operation procedures” refers to steps or sequences of actions, expressed in natural language or a structured format, that specify how to configure, control, or modify an information processing apparatus or a communication apparatus to address an incident.

The term “executable processing targets” refers to specific operations, scripts, commands, or automated workflows within the managed computing environment that can be invoked or controlled by the processor to implement an operation procedure.

The term “failure-response result” refers to data representing the actual processing executed in response to proposal information and an outcome status indicating whether the processing resolved, partially resolved, or failed to resolve the incident.

The term “learning data” refers to stored data sets derived from failure-response results, historical failure-response information, and incident information, which are used to train, update, or adjust analytical models and prompt-construction logic executed by the processor.

The term “occurrence patterns of failures” refers to statistical or logical relationships between operational conditions and resulting failures, learned by the processor from historical data, which can be used to predict or interpret future failure events.

The term “effectiveness of countermeasures” refers to a measure, determined by the processor from past results, of how reliably particular countermeasures lead to successful resolution of incidents under certain conditions.

The term “weighting in estimation of the candidate failure causes” refers to parameters used by the processor to adjust relative importance or contribution of different features or evidence when computing confidence scores for candidate failure causes.

The term “elements of the prompt sentence” refers to component parts of the prompt sentence, such as summaries of symptoms, candidate causes, past cases, response results, constraints, and requested output forms, which are selected and ordered by the processor.

The term “ordering of description in the prompt sentence” refers to the sequence in which elements of the prompt sentence are arranged, which influences how the generative artificial intelligence model interprets and responds to the prompt.

The term “safety condition” refers to one or more rules or constraints that define prohibited or restricted operations, such as actions that may cause data loss, system instability, or security breaches, which are used to filter or qualify proposal information.

The term “output-format condition” refers to requirements on the structure, style, or format of the proposal information, such as stepwise numbering, section separation, or inclusion of specific fields, imposed by the processor on the generative artificial intelligence model.

The term “restrict response content of the generative artificial intelligence model” refers to controlling or constraining, by use of prompt design and post-processing logic, the types of operation instructions and explanations that are accepted or presented from the model's output.

The term “operation instructions that violate the safety condition” refers to recommended actions, included in the model's raw output, that conflict with one or more safety conditions, such as instructions to delete critical data, disable security mechanisms, or unduly disrupt services.

In one embodiment, a server implements the claimed system by executing a program stored in a non-transitory computer-readable medium. The server includes at least one processor, a main memory, a persistent storage device, and a network interface. The server cooperates with one or more terminals operated by a user. The terminals may be workstation computers, portable information devices, or other display and input devices, each including a processor, a memory, a display unit, and an input interface such as a keyboard, pointing device, or touch panel.

The server executes an operating system such as a general-purpose server operating system, and runs middleware including a web application server, a database management system, and log collection software. In one example, the server uses log collection software such as rsyslog, syslog-compatible collectors, or agent-based collectors. The server uses a database system such as a relational database or a document-oriented database to store historical failure-response information, operational information, and learning data. The server further uses a vector database or an approximate nearest neighbor index to store vector representations of incidents and textual content. The server executes a trained generative AI model, which may be a transformer-based language model, either locally on a graphics processing unit or via a network connection to an external AI inference service.

The server acquires operational information from an information processing apparatus and a communication apparatus via the network interface. The operational information includes device logs, system metrics, and configuration change records output by physical or virtual servers, network switches, routers, firewalls, storage devices, and similar components. The server uses a log parser implemented, for example, by log processing software or a custom parsing routine, to convert raw log messages into a structured data representation. The server parses fields such as timestamp, source host identifier, process identifier, severity level, and message body, and stores them as records in the database. The server further computes derived metrics from the operational information, such as moving averages of CPU utilization, memory usage ratios, disk fill rates, error count per unit time, and packet loss ratios.

The server normalizes heterogeneous operational information into structured information by mapping various raw data formats to a common schema. The server assigns each record a device identifier, a service identifier, and a metric or event type, and transforms numeric values into a unified unit space. The server generates a structured representation such as a key-value structure or a relational table row for each operational information item. This normalization reduces the number of conditional branches and string operations required in subsequent analysis stages, and enables more efficient index-based retrieval and vectorization, thereby improving processing speed and memory utilization.

The server records historical failure-response information in the storage unit. The historical failure-response information includes, for each past incident, identifiers of affected devices, time ranges, observed symptoms, candidate causes, applied countermeasures, resolution status, and quantitative outcome metrics such as time-to-recovery. The server generates, for each resolved incident, a compact incident summary object and a corresponding outcome object, which are linked via a shared incident identifier. The server stores these objects in database tables accessible by the analysis and learning modules.

The server analyzes operational information and historical failure-response information to detect a symptom of a failure and to generate structured incident information. The server first detects deviation of metrics from learned normal patterns by using statistical models or machine-learning anomaly detectors. For example, the server may use a time-series forecast model, such as an autoregressive model or a recurrent neural network, to predict expected metric values and then compare actual values to predicted values. When the deviation exceeds a threshold computed from the forecast error distribution, the server flags a potential symptom. In addition, the server uses classification models, such as gradient-boosted trees or multi-layer perceptrons, trained on vectorized log messages and metrics, to classify events into categories like “CPU overload,” “memory exhaustion,” “network congestion,” or “storage failure.”

The server creates structured incident information by aggregating related symptoms and classification results over a time window and by associating them with device identifiers and service identifiers. The server merges operational information records that share similar timestamps and device identifiers into an incident context. The server attaches candidate failure causes to this incident context by matching the current feature vector against historical cases stored in a vector index. The server uses a similarity measure, such as cosine similarity between latent representations produced by a bidirectional encoder or a transformer encoder, to retrieve past cases with similar symptom patterns. The server then uses a cause-estimation model, which may be a logistic regression or a neural network that takes as input both current features and similarity scores to past cases, to output probabilities of multiple candidate failure causes. The server stores the incident context, candidate causes, and references to past cases as structured incident information.

The server refers to technical reference information stored in the storage unit. The technical reference information includes device specifications, recommended configuration ranges, known failure modes, and manufacturer troubleshooting procedures. The server indexes this information by device type, software version, error code, and keyword, and converts text content into vector form using an embedding model. By combining this vectorized reference information with vectorized log content and historical incident summaries, the server can associate technical reference entries with candidate causes and potential countermeasures. The server thus enriches structured incident information with links to relevant reference items and extracted constraints, such as maximum safe restart frequency or configuration parameter boundaries.

The server generates a prompt sentence including a natural-language inquiry based on the incident information. To construct the prompt sentence, the server uses a template that defines slots for symptom summary, candidate causes with probabilities, relevant past cases with summarized responses and results, and extracted constraints from technical reference information. The server uses a rule-based ordering algorithm that arranges these elements such that the most relevant and effective information, learned from past successes, appears earlier in the prompt. For example, the server may place the highest-probability cause and its most successful past countermeasure immediately after the symptom description, because empirical feedback indicates that such ordering improves the quality and convergence of generated instructions.

The server outputs a prompt sentence in natural-language text form, such as:

“A monitoring system has detected a critical incident on an application server.
Device: application server identified as server X.
Symptom: CPU usage has remained above 95% for 25 minutes, and multiple ‘OutOfMemoryError’ events have been logged from the service component.
Probable cause (82% confidence): memory leak in the service component.
Similar past case: on 2024-03-10, increasing the heap size and restarting the service resolved the incident within 5 minutes.

Based on this information, propose the most effective and safe countermeasures. Provide step-by-step actions that an operator can execute, including immediate mitigation and long-term prevention.”

The server then appends explicit constraints and formatting instructions, such as:

“Return the answer as a numbered list of steps. Do not suggest actions that may cause loss of user data, such as deleting log files or resetting persistent storage, unless such actions are clearly justified and labeled as high-risk.”

The combined text constitutes the prompt sentence that will be input to the generative AI model.

The server executes a generative AI model implemented, for example, as a transformer-based language model with multiple attention layers, feed-forward blocks, and layer normalization. The model receives tokenized text of the prompt sentence. The server converts the prompt sentence into embedding vectors by using a token embedding layer and a positional encoding scheme. The transformer blocks compute context-aware representations through multi-head self-attention layers and successive non-linear transformations. The server configures inference parameters such as maximum output length, sampling temperature, and top-k or nucleus sampling thresholds, and may further specify logit bias parameters to discourage certain tokens, such as tokens that correspond to unsafe operations.

The server causes the generative AI model to output proposal information in the form of natural-language text. The proposal information includes, for example, a short explanation of the likely cause, a prioritized list of countermeasures, verification steps, and contingency plans. The server parses the model output into structured segments based on numbering patterns and keyword markers, and associates each segment with an internal representation of an operation procedure. The server also applies post-generation filtering using rule-based checks and pattern matching to detect mentions of actions that violate safety conditions, such as direct manipulation of core system files or deactivation of security subsystems, and marks such suggestions for exclusion or warning.

The server converts the proposal information into display information that the terminal can present. The server formats the proposal information into a structured representation, including headings for “Summary,” “Immediate actions,” “Verification steps,” and “Long-term measures.” The server embeds identifiers that correspond to executable processing targets, such as script identifiers, automated orchestration tasks, or configuration management playbooks. For example, when the proposal includes a step “Restart the service component on server X,” the server links this step to a specific automation action, such as an orchestration job that issues a restart command via a management interface.

The terminal obtains the display information from the server via a communication protocol such as HTTPS. The terminal decodes the structured representation and renders a graphical user interface. The terminal displays a panel showing current incident details, a list of generated steps, and controls that allow the user to inspect each step and, if permitted, trigger automatic execution. The terminal may also render performance graphs using visualization libraries, displaying CPU usage and memory utilization curves that illustrate the incident context. The terminal highlights safety-related annotations, such as warnings on high-risk steps flagged by the server, to assist the user in decision-making.

The user reviews the displayed proposal information on the terminal. The user may choose to execute some operation procedures automatically by selecting corresponding controls. When the user initiates such execution, the terminal sends an execution request to the server, specifying the incident identifier and selected operation procedure. The server translates the request into a control command toward the relevant information processing apparatus or communication apparatus, for example, by invoking an orchestration API, issuing a remote command, or modifying a configuration via a dedicated management interface. In this way, the system is not limited to abstract recommendations; it directly controls real computing and networking devices based on structured associations between proposal information and executable processing targets.

The server acquires content of processing executed and success or failure results. The server logs executed operation identifiers, timestamps, and outputs from the controlled apparatuses, such as success codes or error messages. The server determines whether the incident has been resolved by monitoring operational information after the execution. The server records a failure-response result that links the incident, the executed procedures, and the observed outcome. The server may also accept feedback entered by the user through the terminal, such as qualitative comments on observed behavior or partial success.

The server uses accumulated failure-response results and historical failure-response information as learning data. The server updates internal statistical models and machine-learning models by performing periodic training processes. For supervised learning, the server uses pairs of incident features and selected countermeasures with associated success labels. The server defines a loss function, such as cross-entropy loss for classification of effective counters or mean squared error for predicted improvement in metrics. The server applies gradient-based optimization, such as stochastic gradient descent or adaptive moment estimation, to update weights of classification and ranking models that estimate candidate failure causes and prioritize operation procedures. The server can also update parameters of the incident-to-vector encoder used for retrieval of past cases.

The server adjusts the construction of prompt sentences based on the effectiveness of past proposal information. The server computes, for each type of prompt element (e.g., detailed symptom description, high-level cause summary, explicit constraints), a contribution score based on how often the inclusion of that element correlates with successful incident resolution. The server then modifies the template for future prompts by reordering elements, changing level of detail, or adding or omitting specific technical reference snippets. For example, if prompts that include explicit numeric thresholds and device firmware versions lead to more accurate and implementable recommendations than generic prompts, the server increases the probability of including such details and moves them to earlier positions in the prompt text. This dynamic optimization of prompt composition improves the model's effective use of context and reduces the number of inference calls needed to obtain reliable proposal information.

The server enforces safety conditions and output-format conditions by embedding them both in the prompt sentence and in post-processing rules. The server uses a safety rule base in which prohibited or restricted operations are represented as patterns, such as specific command forms or configuration operations. The server analyzes model outputs using pattern matching and semantic similarity checks to detect operations close to those listed in the safety rule base. The server modifies or suppresses unsafe portions of the generated text before they reach the terminal. This two-layer mechanism reduces the computational burden of reprocessing unsafe instructions and lowers the risk of presenting hazardous commands, thereby enhancing the reliability and robustness of the computer system.

The server thus improves computer technology in multiple ways. The normalization of heterogeneous operational data to structured incident information reduces unnecessary string-handling overhead and allows for more efficient vectorized operations, which speeds up incident analysis. The integration of learned weighting in candidate cause estimation and prompt-element ordering reduces the number of iterations needed to obtain a useful generative AI output, which lowers computational load and latency. The feedback-driven optimization of incident-analysis models and prompt-construction strategies enables the system to converge toward more precise and concise prompts and countermeasures, reducing unnecessary communication and storage of redundant data. The close coupling between generated proposal information and executable processing targets allows the server to carry out fine-grained device control operations that are synchronized with real-time monitoring, thereby shortening resolution time and stabilizing system performance.

In another embodiment, the server executes a locally hosted generative AI model that has been fine-tuned on domain-specific incident and resolution texts. The server builds a training dataset by segmenting historical incident reports and operator notes into input-output pairs, where the input includes structured incident information converted to text, and the output includes known successful countermeasures and rationales. The server uses a sequence-to-sequence learning framework with a transformer encoder-decoder architecture, defines a training loss based on token-level cross entropy, and performs gradient updates using mini-batches. The server may apply data augmentation techniques, such as paraphrasing of symptom descriptions or reordering of neutral steps, to improve generalization. This embodiment allows the system to tailor generative behavior to the particular operational environment while further improving the alignment between generated text and available automation procedures.

In yet another embodiment, the server does not host the full generative model but uses a remote AI service. The server still constructs optimized prompt sentences, applies local pre- and post-processing, and enforces safety and formatting conditions. The server may compress incident information before insertion into the prompt, for example by encoding structured fields into compact tokens or abbreviations, to reduce payload size and communication latency. The server may also cache frequently used prompt fragments and their corresponding responses in a local cache storage to avoid redundant inference calls. This caching mechanism reduces network load and external API usage while maintaining responsiveness.

In a further embodiment, the terminal implements additional local logic. The terminal may locally render precomputed visualizations based on data received from the server, such as plotting time-series data in a graphics subsystem without requiring repeated server-side rendering. The terminal may also locally validate user actions against a subset of safety rules, preventing accidental initiation of restricted operations, which decreases overall error probability and improves user interface robustness.

Through these embodiments, the server, the terminal, and the user cooperate in a system that uses specific data structures for incident representation, explicit conversion of structured incident information into optimized prompt sentences for a generative AI model, and feedback-driven learning to improve incident analysis and device control. The described technical configuration and processing improve processing speed, accuracy of failure cause estimation and countermeasure selection, safety of generated operational instructions, and efficiency of computing and communication resources, thereby providing a concrete improvement in computer technology beyond mere automation of human judgment.

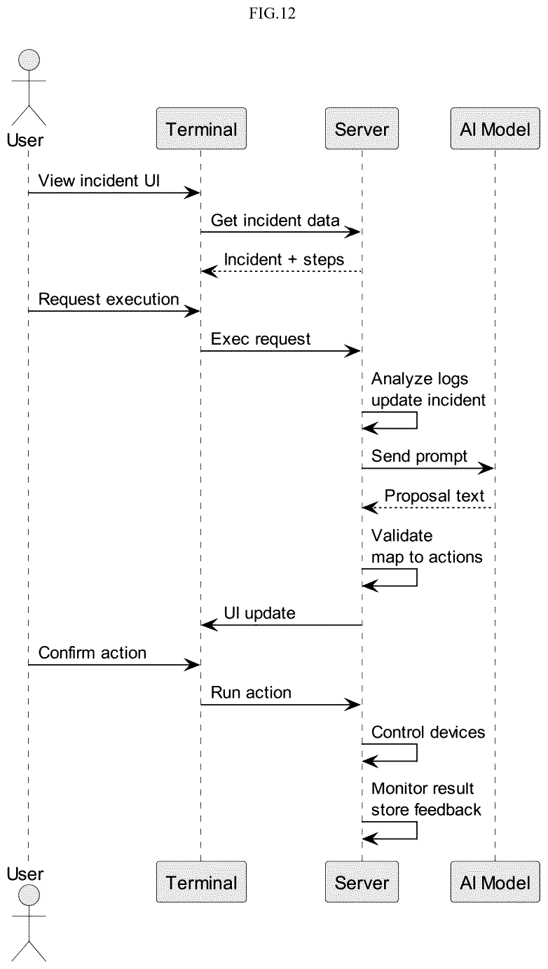

The following describes the processing flow using FIG. 12.

### Step 1:

The server acquires raw operational information from an information processing apparatus and a communication apparatus via a network interface.

The input is a stream of raw log messages, metric records, and configuration-change notifications.

The server parses each log message to extract fields such as timestamp, source identifier, severity, and message text, and the server converts metric records to a unified numerical format.

The server performs data processing by tokenizing log lines, splitting by delimiters, applying regular expressions, and mapping various source-specific keys into a common key set.

The output is a set of normalized records represented as structured data objects (for example, key-value pairs) that are ready to be stored in the storage unit.

### Step 2:

The server stores normalized operational information and historical failure-response information in the storage unit.

The input is the structured data objects produced in Step 1 and any newly generated failure-response result objects.

The server performs data processing by assigning each record a unique identifier, indexing fields such as device identifier, time, and event type, and writing the records into database tables or collections.

The server updates secondary indices and, when necessary, summary tables that aggregate counts and averages per time window.

The output is a set of persistent records and indices that can be efficiently queried for later analysis.

### Step 3:

The server detects symptoms of failures based on the stored operational information.

The input is time-ordered normalized operational information for each device and service.

The server performs data processing by computing time-series features, such as moving averages and variances, and by applying thresholds and anomaly-detection models to these features.

The server may, for example, compare current CPU usage to a baseline predicted by a time-series model and calculate a deviation score; if the deviation score exceeds a learned threshold, the server flags an anomaly.

The output is a set of symptom events, each containing a reference to affected devices, time intervals, and abnormal feature values.

### Step 4:

The server classifies the type of failure associated with each detected symptom.

The input is the set of symptom events from Step 3 and related operational information records within a time window around each symptom.

The server performs data processing by vectorizing text fields from log messages (for example, using a word or sentence embedding model) and concatenating these vectors with numerical metrics to form feature vectors.

The server applies a trained classification model, such as a neural network or gradient-boosted trees, to these feature vectors to output probabilities for multiple failure categories.

The output is, for each symptom event, a classification result that associates the event with one or more candidate failure categories and their confidence scores.

### Step 5:

The server generates structured incident information by aggregating related symptom and classification results.

The input is the classification results from Step 4 and the underlying operational information and device configuration metadata.

The server performs data processing by grouping events that share device identifiers and overlapping time ranges, and by merging their features into a single incident context.

The server attaches candidate failure causes to each incident by interpreting classification outputs as cause probabilities and by annotating them with relevant metadata (for example, device type and software version).

The output is structured incident information that includes incident identifiers, summarized symptoms, candidate failure causes, and links to the original operational records.

### Step 6:

The server retrieves and analyzes historical failure-response information and technical reference information relevant to each incident.

The input is the structured incident information from Step 5, the stored historical failure-response records, and the stored technical reference information.

The server performs data processing by querying the database for past incidents matching device type, failure category, and error patterns, and by computing vector similarities between current incident vectors and stored incident vectors.

The server selects a set of past cases with highest similarity scores and extracts their applied countermeasures and results; the server also queries reference information entries aligned by device type, error codes, or keywords.

The output is an enriched incident context that includes references to past cases, their success or failure, and associated technical reference entries.

### Step 7:

The server estimates candidate failure causes and ranks potential countermeasures based on enriched incident context.

The input is the enriched incident context from Step 6, including similarity scores, past response results, and technical constraints.

The server performs data processing by running a cause-estimation model that takes as input feature vectors derived from current symptoms and historical match information, and outputs refined probability scores for multiple candidate causes.

The server further aggregates statistics of past countermeasures (for example, success frequency and average time-to-recovery) for each candidate cause, and computes a ranking score for candidate countermeasures.

The output is a refined incident representation that specifies top-ranked candidate failure causes and prioritized countermeasure options.

### Step 8:

The server constructs a prompt sentence for a generative AI model based on the refined incident representation.

The input is the refined incident representation from Step 7, including symptom descriptions, candidate causes, past case summaries, and countermeasure rankings.

The server performs data processing by filling a prompt template with textual summaries, arranging elements (such as symptom description, most probable cause, and most successful past countermeasure) according to learned ordering rules, and inserting explicit instructions and constraints for the generative AI model.

The server may transform numerical metrics into human-readable phrases (for example, “CPU usage above 95% for 25 minutes”) and embed confidence scores as approximate percentages.

The output is a complete prompt sentence in natural language that includes a clear inquiry and explicit constraints.

### Step 9:

The server sends the prompt sentence to a generative AI model and obtains proposal information.

The input is the prompt sentence from Step 8.

The server performs data processing by tokenizing the prompt sentence, encoding tokens into embeddings, and applying a transformer-based generative model to compute output token probabilities step by step.

The server decodes the output tokens into natural-language text, possibly using sampling parameters such as temperature and top-k thresholds to control diversity, and concatenates the tokens into complete sentences and numbered lists.

The output is proposal information text that includes an explanation of likely causes, a sequence of recommended actions, verification steps, and possible long-term measures.

### Step 10:

The server validates and structures the proposal information to associate it with executable processing targets.

The input is the proposal information text from Step 9 and internal safety rules and mapping tables.

The server performs data processing by parsing the proposal text into discrete steps, using pattern recognition or markers such as numbered lists, and by matching each step against a catalog of known operations and automation scripts.

The server checks each step for prohibited or restricted operations by comparing it with safety rule patterns and computes a safety flag; for steps that map to valid operations, the server attaches identifiers of executable processing targets.

The output is a structured proposal object that includes, for each step, textual description, mapped executable target (if any), and safety annotations.

### Step 11:

The server generates display information for the terminal based on the structured proposal object and incident context.

The input is the structured proposal object from Step 10 and related incident information such as metrics and log excerpts.

The server performs data processing by constructing a layout description that organizes incident summary, graphs, and recommended steps, and by embedding metadata such as step identifiers and action types into the layout description.

The server may also compute compact representations for visualization, such as pre-aggregated time-series data samples, to reduce transmission size.

The output is display information, formatted as structured data suitable for rendering a user interface on the terminal.

### Step 12:

The terminal receives display information from the server and renders a user interface for the user.

The input is the display information from Step 11.

The terminal performs data processing by parsing the structured data, mapping fields to UI components, and drawing text blocks, tables, and graphs on the display.

The terminal assigns event handlers to interactive elements, such as buttons for executing or skipping a step, based on identifiers and safety flags included in the display information.

The output is a rendered graphical or textual interface that presents incident details and recommended actions to the user.

### Step 13:

The user inspects the displayed information and selects operation procedures to be executed.

The input is the rendered user interface showing incident context, recommended steps, and safety warnings.

The user performs cognitive processing to evaluate the recommendations and, using input devices, selects one or more steps to execute or to mark as completed.

The user may also input comments about expected risks or particular constraints.

The output is a set of user actions, including execution requests and optional annotations, transmitted from the terminal to the server.

### Step 14:

The server executes or triggers execution of selected operation procedures on target apparatuses.

The input is the set of user actions from Step 13, including identifiers of selected steps and corresponding executable processing targets.

The server performs data processing by translating step identifiers into concrete control commands, such as orchestration API calls, configuration changes, or service restarts, and by scheduling these commands while respecting safety flags and execution policies.

The server sends appropriate control messages to the information processing apparatus or communication apparatus and logs command issuance and responses.

The output is a series of execution results, including status codes and messages from the controlled apparatuses.

### Step 15:

The server evaluates the outcome of the executed procedures and records a failure-response result.

The input is the execution results from Step 14 and updated operational information from the apparatuses after execution.

The server performs data processing by comparing post-execution metrics and log patterns to pre-execution values, determining whether the symptom has disappeared or decreased, and categorizing the outcome as resolved, partially resolved, or not resolved.

The server then creates a failure-response result object linking the incident, executed steps, and the outcome category, and stores this object in the storage unit.

The output is updated historical failure-response information that includes the new result.

### Step 16:

The server updates learning data and refines analysis and prompt-construction parameters based on accumulated failure-response results.

The input is the updated historical failure-response information from Step 15 and previously stored learning data.

The server performs data processing by aggregating statistics of success and failure for different candidate causes, countermeasures, and prompt configurations, and by computing gradients of a predefined loss function over a training set constructed from incidents and outcomes.

The server updates weights of analytical models (for example, cause-estimation classifiers) and adjusts rules or coefficients used to select and order prompt elements, thereby changing how future incident contexts are converted into prompt sentences.

The output is a set of updated model parameters and prompt-construction rules that will be applied in subsequent incident analyses and generations.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In the operation of complex information systems, operators typically rely on server-side software to process machine-generated log data, retrieve historical incident records, and consult technical documentation in order to diagnose failures and determine corrective actions. Conventional systems generally perform rule-based parsing of log messages and static correlation with manually curated rules or fixed playbooks. Such systems suffer from several technical limitations in the underlying computer technology.

First, conventional log analysis pipelines treat log normalization, failure classification, and countermeasure generation as isolated subsystems with rigid interfaces. Log collectors often simply store normalized logs in databases or message queues without integrating them with learned models or adaptive control logic. As a result, the server must execute multiple disjoint processing paths, causing redundant data movement, increased memory usage, and latency when combining log-derived features with historical records and documentation. The computer system therefore fails to efficiently compute a context-rich representation of the current incident that is suitable for automatic generation of actionable procedures.

Second, traditional failure diagnosis systems do not incorporate a structured representation of user interaction signals and do not estimate the user's emotional or cognitive state as part of the server-side computation. Existing user interfaces may collect basic click logs, but the server typically uses these logs only for coarse analytics and not as real-time input to core decision logic. As a consequence, the server cannot adapt its processing flow or its output data structures in response to high-stress or confusion states of the operator. This leads to uniform, non-adaptive responses that may overload the user interface with information, increase the likelihood of operator error, and fail to leverage available interaction data as a useful computational signal.

Third, even when large-scale neural language models (generative AI models) are added to such systems, they are often invoked in an ad hoc manner with manually written prompts. The server frequently transmits raw log text or loosely organized summaries to the generative AI model, without a systematic prompt construction mechanism that incorporates structured anomaly analysis, historical statistics, documentation snippets, and real-time emotion estimation. This causes unstable and inconsistent outputs, places a burden on engineers to handcraft prompts, and prevents the system from programmatically optimizing prompt patterns based on observed performance. In addition, conventional systems do not provide a mechanism by which the server parses the generative AI model outputs into machine-usable, structured countermeasure plans that can be tightly integrated back into the server's data flow and UI control logic.

Fourth, feedback from actual incident handling, such as per-step execution results, outcome success or failure, work time, user ratings, and temporal emotional states, is typically not captured in a unified, machine-readable format suitable for retraining and tuning the server's models and templates. As a result, the server-side models for anomaly analysis, emotion estimation, and prompt generation remain static or require manual offline tuning. This hinders continuous improvement of classification accuracy, reduces the robustness of the generative AI-based outputs, and prevents the system from automatically adjusting its behavior to observed patterns of user performance and satisfaction.

Accordingly, a technical problem exists in providing a server-side architecture and processing flow that: (i) tightly integrates log normalization, anomaly classification, historical retrieval, and documentation extraction into a coherent, structured context; (ii) computes and uses an operator's emotional state as a first-class signal in server processing; (iii) programmatically constructs and optimizes prompt sentences to generative AI models from this context; (iv) parses the generative AI outputs back into structured, risk-aware countermeasure procedures; and (v) uses feedback data to automatically retrain and adjust classification models and prompt templates. The technical problem further includes reducing latency and computational redundancy while improving the relevance, stability, and adaptiveness of the generated troubleshooting procedures, thereby improving the functioning of the computer system itself in failure response scenarios.

The specific processing by the specific processing unit 290 of the data processing device 12 in Example 2 is realized by the following means.

The present invention provides a server comprising a processor configured to normalize log information output from communication apparatuses into structured data, to analyze the structured data by applying both rule sets and a machine learning model to determine an anomaly cause candidate, to retrieve and summarize past incident history and documentation snippets related to the anomaly cause candidate, to compute an emotional state of a user from operation history and multimodal input signals, to generate a prompt sentence for a generative AI model by embedding the anomaly cause candidate, the historical summaries, the documentation snippets, and the emotional state into a selected template, to invoke the generative AI model using the prompt sentence and parse a natural-language response into structured countermeasure procedure data with step-level risk annotations, to control generation of user interface data including a display mode that is selected based on the emotional state, and to record step execution results and user feedback as learning data for updating the anomaly analysis, emotion estimation, and prompt generation components.

This enables the server to implement an integrated computation pipeline in which log-derived features, historical statistics, documentation content, emotional state estimation, and generative AI interaction are combined within a single machine-executable control flow, thereby reducing redundant processing, improving the accuracy and stability of anomaly classification and countermeasure generation, dynamically adapting prompt sentences and presentation formats to the user's state, and continuously improving the underlying models and templates based on structured feedback, which in turn enhances the overall performance and reliability of the computer system in performing failure diagnosis and response.

The term “communication apparatus” refers to any hardware device capable of transmitting log information over a communication network, including but not limited to network nodes, computing devices, or other electronic equipment that outputs operational or error logs.

The term “log information” refers to machine-generated data records indicating operational states, events, or errors of a communication apparatus, typically formatted as text messages including time, identifier, severity, and descriptive content.

The term “pattern matching of character strings” refers to a computational process of analyzing text by applying predefined rules or expressions, such as regular expressions, to identify and extract specific substrings corresponding to structured fields.

The term “time information” refers to data representing the occurrence time of an event described by log information, including timestamps or equivalent temporal indicators.

The term “identification information” refers to data used to distinguish a source or target of log information, such as a device identifier, host name, or process identifier.

The term “anomaly code” refers to a symbol, code, or label included in log information that indicates a specific type of abnormal event or error condition.

The term “message body” refers to a textual portion of log information other than metadata fields, describing details of an event, status, or error in natural language or structured text.

The term “structured data” refers to data organized into a predefined format with explicit fields and values, such as records encoded in a markup or serialization format that can be directly processed by machine-executable logic.

The term “stream-processing infrastructure” refers to a software and hardware framework that enables continuous ingestion, buffering, and distribution of data records as a sequence of messages, allowing downstream components to consume and process the data in near real time.

The term “information storage device” refers to any hardware component or combination of components configured to store digital data persistently, including but not limited to disk storage, solid-state storage, and network-attached storage.

The term “history information” refers to stored data describing past anomaly-related events, including attributes such as occurrence times, associated apparatuses, anomaly codes, estimated causes, executed procedures, durations, and outcomes.

The term “query language” refers to a formal language used to specify retrieval conditions against stored data, including but not limited to relational query languages or equivalent declarative access mechanisms.

The term “similar events” refers to historical anomaly-related records that share at least one common characteristic, such as the same or related anomaly code, anomaly category, or apparatus type, with a current event under analysis.

The term “statistical values” refers to numerical measures computed over one or more sets of data, such as averages, medians, success rates, counts, or distributions that summarize characteristics of historical events or procedures.

The term “apparatus description document” refers to any technical documentation describing specifications, configuration methods, operational procedures, or troubleshooting instructions for a hardware or software apparatus, stored in a machine-readable form.

The term “full-text search” refers to a retrieval process that indexes and searches entire textual contents of documents, enabling matching based on words, phrases, or expressions contained anywhere within the documents.

The term “snippet information” refers to a subset of text extracted from one or more documents, including key phrases, sentences, or paragraphs summarizing relevant procedures or cautions for a given anomaly.

The term “operation history” refers to data representing a sequence of user interactions with a user interface, including events such as screen transitions, selections, retries, and their associated timestamps.

The term “character input information” refers to text entered by a user through input devices or user interface components, including but not limited to comments, queries, feedback entries, or command-like input.

The term “audio input information” refers to digitized sound data acquired from a user through an audio capture device, such as a microphone, and transmitted to a processing component.

The term “emotion classification model” refers to a computational model, often implemented using machine learning or statistical techniques, that receives one or more input features and outputs labels or scores indicating emotional categories.

The term “emotion label” refers to a symbolic representation of a predicted emotional category, such as high stress, confusion, neutrality, or confidence, assigned to a user state by an emotion classification model.

The term “emotional state” refers to data indicating a current or recent psychological condition of a user, expressed as a category or set of scores derived from behavioral, textual, or audio signals.

The term “rule set” refers to a collection of predefined logical conditions or patterns that map input data features to one or more intermediate or final conclusions, such as anomaly categories.

The term “machine learning model” refers to a parameterized computational structure that has been trained using example data to perform tasks such as classification, regression, or prediction on new input data.

The term “probability value” refers to a numeric value, typically within a normalized range, representing a degree of likelihood that an input belongs to a specific category or outcome.

The term “anomaly category” refers to a classification label representing a type or class of abnormal condition, such as connection failure, configuration error, or resource exhaustion.

The term “anomaly cause candidate” refers to a hypothesized root cause or primary factor for an observed anomaly, determined by combining outputs of rule sets and machine learning models.

The term “summary data of past events” refers to condensed information derived from historical anomaly-related records, including representative procedure patterns, success metrics, and characteristic attributes.

The term “template” refers to a predefined text structure with placeholders into which variable content such as anomaly descriptions, historical summaries, or documentation snippets can be inserted.

The term “instruction content” refers to textual elements within a prompt specifying constraints or requirements on the output of a generative AI model, including format, level of detail, and tone.

The term “prompt sentence” refers to text input provided to a generative AI model that includes context information, instructions, and conditions intended to guide generation of an output.

The term “generative AI model” refers to an artificial intelligence model, typically a language model, trained on data to generate natural-language text or similar content in response to provided prompts.

The term “countermeasure procedure text” refers to a sequence of natural-language instructions produced by a generative AI model, describing steps to diagnose or mitigate an anomaly.

The term “numbered step” refers to a portion of text identified as a distinct action or instruction, marked by an ordinal indicator such as a step number in a list.

The term “operation content” refers to a description of an action or series of actions that a user or system should perform as part of a countermeasure procedure.

The term “execution example” refers to a concrete instance of an operation, such as a command-line instruction or configuration action that exemplifies how to perform a step.

The term “warning statement” refers to text that notifies a user of potential risks, side effects, or prerequisites associated with a given operation or step.

The term “risk information” refers to data associated with a step or operation that indicates a level or type of potential adverse impact, such as service interruption or configuration loss.

The term “user interface data” refers to data structures specifying content, layout, and behavior for display on a user terminal, including steps, warnings, and control elements.

The term “sequential display format” refers to a mode in which user interface data is presented step-by-step, such that only one or a subset of steps is displayed at a time in a predefined order.

The term “list display format” refers to a mode in which multiple steps of user interface data are presented concurrently, allowing a user to view, scroll, or expand several steps in one screen or view.

The term “terminal device” refers to an end-user computing device capable of receiving user interface data, rendering a user interface, accepting user input, and communicating with a server, including but not limited to personal computers and mobile devices.

The term “feedback recording unit” refers to a functional component that collects, associates, and stores user-related execution results, evaluations, and emotional state data together with historical anomaly records for later analysis and learning.

The term “execution result of respective steps” refers to data indicating, for each step in a countermeasure procedure, whether the step was executed, completed, succeeded, or failed, and optionally additional observations.

The term “user evaluation” refers to data expressing a user's subjective assessment of clarity, usefulness, workload, or other aspects of the generated procedures or system behavior.

The term “learning data” refers to data sets prepared and stored for use in training, retraining, or tuning machine learning models, including anomaly classification models, emotion classification models, and prompt generation logic.

The term “machine learning algorithm” refers to a computational procedure that adjusts parameters of a machine learning model based on learning data, with the objective of improving performance on one or more tasks.

The term “anomaly category classification model” refers to a machine learning model that receives input features derived from log information or structured data and outputs one or more anomaly categories and associated probabilities.

The term “emotion estimation unit” refers to a functional component that includes logic and models for computing an emotional state of a user from one or more input signals.

The term “prompt generation unit” refers to a functional component that constructs prompt sentences by selecting templates, inserting context information, and adding instruction content for a generative AI model.

The term “presentation control unit” refers to a functional component that determines, based on structured procedure data and emotional state, how countermeasure procedures are formatted and delivered as user interface data to a terminal device.

The term “high-stress and confused state” refers to an emotional state classification indicating that a user is experiencing elevated stress and uncertainty or difficulty in understanding or proceeding with tasks.

The term “calm and confident state” refers to an emotional state classification indicating that a user is experiencing low stress and a high degree of assurance or familiarity with the tasks.

The term “dynamic switching” refers to a behavior of the system in which parameters such as prompt sentence structure or user interface display mode are changed during operation in response to updated emotional state or other contextual signals.

In one embodiment, a server, a terminal, and a user cooperate to implement the system according to the above claims. The following describes exemplary hardware and software configurations and concrete data processing performed by the server and the terminal.

Server executes a server-class operating system on one or more general-purpose processors, such as multi-core CPUs, and may further use one or more accelerator devices, such as GPUs optimized for matrix operations. Server connects to multiple communication apparatuses and multiple terminals via one or more networks, such as local area networks and wide area networks. Server executes an HTTP-based application framework implemented, for example, using a web framework in a general-purpose programming language, and exposes application programming interfaces for log transfer, user interaction, and integration with a generative AI model.

Server uses a log daemon, for example a syslog-compatible daemon process, to receive log information from communication apparatuses over the network. Server uses a network interface controller to listen on a specified port for syslog packets and stores each received log line as a raw text string in main memory. Server then executes a log collection module implemented in a scripting language such as Python. Server applies regular expressions, implemented via a regular expression library, to each log line to extract time information, identification information, anomaly codes, severity levels, and message bodies. Server converts these extracted elements into structured data, such as JSON-like records, and assigns each record a unique identifier. Server optionally publishes the structured data to a distributed stream-processing infrastructure, such as a message queue system, so that downstream modules can consume the data in a streaming fashion.

Server uses an anomaly analysis module to determine an anomaly cause candidate from the structured data. Server first applies a rule set implemented as a mapping between patterns in message bodies and anomaly categories. For example, Server uses a table in which the phrase “link down” maps to a “physical_link_failure” category and the phrase “authentication failed” maps to an “authentication_failure” category. Server uses pattern matching functions to check whether any of these predefined phrases appear in the message body and obtains one or more intermediate anomaly category candidates.

Server then applies a machine learning model to the same message body. Server uses a tokenizer associated with a transformer-based neural network architecture, such as a transformer encoder with multiple attention layers. Server converts the message body into a sequence of token indices and embeds the indices into vector representations by using an embedding matrix. Server passes the embedded sequence through stacked attention layers and feed-forward layers implemented in a deep learning framework such as PyTorch or TensorFlow. Server applies a classification head, such as a fully connected layer followed by a softmax function, to obtain probability values for multiple anomaly categories. Server thus computes, for each anomaly category, a probability value indicating a likelihood that the category describes the observed event.

Server combines the outputs of the rule set and the machine learning model. For each anomaly category, Server assigns a rule-based score based on the presence or absence of matching patterns in the message body. Server computes a weighted combination of the softmax probability and the rule-based score, for example by a linear combination with preconfigured weights. Server selects the anomaly category with the highest combined score and generates an anomaly cause candidate that includes a label for the category and a short textual description. By combining rules and a learned model in this way, Server improves classification stability and robustness against unforeseen log variations.

Server stores history information in an information storage device, such as a relational database management system (RDBMS). Server defines tables for failure events, procedures, outcomes, and user feedback. Each failure event record includes occurrence time, device identifier, anomaly code, anomaly category, estimated cause, and references to executed procedures. Each procedure record includes ordered steps, commands, and associated risk levels. Server creates indexes over anomaly codes, categories, and device identifiers to accelerate queries. When Server receives a new anomaly cause candidate, Server constructs a query in a query language such as SQL and retrieves similar events. Server groups retrieved events by procedure pattern and computes statistical values, such as success rate and median recovery time, for each group. Server generates summary data of past events, including procedure patterns and statistics, and stores the summary in an internal data structure for later use.

Server manages apparatus description documents, such as operation manuals and troubleshooting guides, in a document storage system and indexes them with a full-text search engine, such as a distributed search engine. Server preprocesses documents by converting PDF or HTML files into plain text using a document parsing tool. Server tokenizes and indexes the text for full-text search. When Server receives an anomaly code and anomaly category, Server constructs a search query including the anomaly code and relevant keywords derived from the anomaly cause candidate. Server sends the query to the search engine and obtains a list of relevant document sections. Server extracts portions of text surrounding top-ranked matches and applies simple summarization logic, such as selecting sentences containing imperative verbs (“check,” “verify,” “reset”) or warning phrases (“caution,” “warning”). Server produces snippet information consisting of concise countermeasure descriptions and caution statements extracted from the apparatus description documents. Terminal executes a client operating system and a web browser acting as an HTTP client. Terminal loads a front-end application implemented with a JavaScript framework such as a component-based UI framework. Terminal renders user interface screens for monitoring, troubleshooting, and feedback.

Terminal records operation history by capturing user interface events. For example, Terminal registers event handlers for page transitions, button clicks, scroll events, and dialog openings. Terminal constructs an operation history record for each event, including event type, element identifier, timestamp, and contextual metadata such as the current anomaly code. Terminal buffers these records locally and periodically transmits them to Server via HTTPS.

Terminal captures character input information through text fields, chat boxes, and feedback forms. Terminal bundles these texts with session identifiers and sends them to Server. In some embodiments, Terminal captures audio input information by using a microphone interface provided by web technologies. Terminal segments captured audio into short clips and transmits the clips to Server for analysis.

Server performs emotion estimation based on operation history, character input information, and audio input information. Server extracts numerical features from operation history, such as number of clicks per unit time, average dwell time on troubleshooting pages, number of times a screen is revisited, and frequency of use of help components. Server normalizes these features and feeds them into a machine learning model implemented with a gradient boosting algorithm or a neural network. Server trains this model offline by using labeled data that associates feature vectors with known stress levels. During operation, Server outputs a stress score or a discrete stress level category for each session.

Server processes character input information by using a natural language processing pipeline. Server tokenizes the text, applies part-of-speech tagging if necessary, and feeds the tokens into a transformer-based emotion classification model. The model outputs emotion labels such as “anger,” “anxiety,” “confusion,” or “neutral,” along with probability scores. Server processes audio input information either by first using an automatic speech recognition model, such as a sequence-to-sequence neural network with attention, to generate text, or by extracting acoustic features such as mel-frequency cepstral coefficients, pitch, and energy. Server feeds the resulting features into an audio emotion classification model. Server then combines stress levels, textual emotion labels, and audio-based scores by computing a weighted sum or by applying a second-level classifier that outputs a final emotional state, such as “high-stress and confused” or “calm and confident.”

Server uses a prompt generation unit to construct a prompt sentence to be input to a generative AI model. Server receives as inputs the anomaly cause candidate, the summary data of past events, the snippet information, and the emotional state. Server maintains multiple templates, stored as text with placeholders for anomaly descriptions, device identifiers, past procedures, manual snippets, and instruction content. Server selects a template based on the emotional state. For example, if the emotional state is “high-stress and confused,” Server selects a template that specifies detailed explanations, plain language, and explicit warnings. If the emotional state is “calm and confident,” Server selects a concise template that emphasizes brevity and assumes a higher level of technical knowledge.

Server fills placeholders in the selected template with the anomaly cause candidate, such as a phrase indicating “connection failure to an authentication server,” with one or more high-success-rate procedures from the summary data of past events, such as “check network reachability, verify NTP time synchronization, re-enter and save authentication settings,” and with key warning statements from the snippet information, such as a note about time synchronization affecting authentication. Server embeds an explicit description of the emotional state and specific instructions for the generative AI model regarding the desired number of steps, required presence of command examples, and formatting of warnings.

In one example, when Server determines that the user is in a “high-stress and confused” state and that device A with device_id A-001 is reporting error code 123 related to an authentication server connection failure, Server constructs the following prompt sentence:

“You are a generative AI model acting as a patient and reassuring network support engineer.

The user is currently under high stress and feels confused.

Device A (device id: A-001) shows error code 123. The estimated cause is ‘connection failure to the authentication server’.

Past successful cases show the following general pattern (success rate around 90%): (1) check network reachability to the authentication server, (2) verify NTP time synchronization, (3) re-enter and save authentication settings.

The official manual warns: ‘If the device time is not synchronized, authentication may fail; always verify NTP status before changing credentials.’

Please generate a step-by-step troubleshooting guide with the following format:
Use a numbered list (1., 2., 3., . . . ).
For each step, first explain the purpose in simple words, then show an example CLI command, and finally highlight any risks.
Use gentle and clear language; assume the user may be very nervous and may not be an expert.
Insert a WARNING line before any operation that could interrupt service.”

Server sends this prompt sentence to a generative AI model via an API. Server may use a large language model deployed in an on-premises environment or a hosted service accessible through a network. Server includes in the request additional parameters such as maximum response length, temperature for controlling randomness, and stopping conditions. The generative AI model, implemented as a large-scale transformer network, generates a countermeasure procedure text in natural language following the instructions in the prompt. Server parses the countermeasure procedure text. Server splits the text based on numbered step indicators, such as lines starting with “1.”, “2.”, and so on. For each step, Server extracts the first sentence as a title or short summary, identifies command-like strings by matching patterns typical of command-line syntax, and detects warning statements through keyword searches for “WARNING,” “caution,” or similar terms. Server converts the results into structured data objects, each object containing a step number, a description, one or more execution examples, and risk information including flags and associated warning text. Server generates user interface data in conjunction with a presentation control unit. Server uses the emotional state to decide whether to present the countermeasure procedures in a sequential display format or a list display format. For a sequential display format, Server marks a UI mode field accordingly and arranges steps in an ordered sequence, with each step designated as a separate screen. For each step with high risk information, Server includes additional metadata instructing the terminal to display warning icons, red text, or confirmation dialogs. For a list display format, Server prepares a data structure containing all steps for simultaneous display, along with indicators for expandable detail sections and associated manual snippets.

Terminal receives the user interface data over HTTPS. Terminal reads the UI mode and renders the corresponding layout. In sequential display mode, Terminal shows one step per screen, including the step number, description, and command examples, and overlays warning messages when required. In list display mode, Terminal shows multiple steps on a single view, with brief summaries initially visible and full descriptions and commands accessible via expand-and-collapse controls. Terminal may provide buttons for marking steps as completed, indicating success or failure, and submitting textual feedback.

User examines the rendered steps on Terminal. User then interacts with the actual communication apparatus using remote access tools such as a command-line shell, a device management console, or a remote console application. User executes the commands suggested in the step descriptions, such as sending ICMP echo requests to authentication servers, checking NTP synchronization status, or editing configuration parameters. User observes the results in real time and returns to the Terminal interface to mark each step as completed and to indicate whether the step succeeded or failed. User may enter comments describing unexpected behavior or environmental constraints.

Terminal transmits per-step execution results, final anomaly handling outcome, time spent on each step, and user evaluations to Server. Terminal also continues to transmit operation history and, if enabled, character and audio input reflecting the user's ongoing state.

Server aggregates these data items and records them in the information storage device as feedback. Server associates each record with the corresponding anomaly cause candidate, countermeasure procedure, and user session. Server thereby accumulates learning data consisting of structured inputs (logs, history, manuals, emotion features, prompt patterns) and structured outputs (generated procedures, user performance, user satisfaction, emotional trajectories).

Server periodically retrieves accumulated learning data to retrain and improve its models. For anomaly classification, Server uses cross-entropy loss between predicted anomaly categories and labels derived from resolved cases. Server updates model weights by stochastic gradient descent or a variant such as Adam. For emotion classification, Server uses training examples built from operation features, text fragments, and audio features labeled with emotional states; Server similarly minimizes an error function and updates model parameters. For prompt generation, Server analyzes correlations between different template variants, prompt phrasing, and observed performance metrics such as procedure success rate or user satisfaction scores. Server adjusts template content by, for example, adding extra warnings to steps that historically led to user mistakes, or shortening explanations in contexts where users with a calm and confident state reported excessive verbosity.

Server, by integrating log normalization, anomaly analysis, history retrieval, document summarization, emotion estimation, prompt generation, generative AI model interaction, UI control, and feedback-based learning into a single coherent data flow, improves the functioning of the computer system. Because Server uses structured data representations, streaming infrastructures, and learned models selected and tuned based on feedback, Server reduces overall processing latency compared to manual or ad hoc pipelines and avoids redundant database accesses by combining features before invoking the generative AI model. Because Server uses anomaly cause candidates and emotional states as explicit inputs into prompt sentences, Server obtains more consistent and context-appropriate outputs from the generative AI model, reducing the need for repeated queries and improving computational efficiency. Because Server parses the generative AI outputs into structured countermeasure procedures and associates them with historical performance, Server can measure and improve the quality of the prompts and models over time, resulting in increased accuracy and decreased error rates in anomaly handling.

Server therefore does not merely automate human reasoning but implements specific algorithms and data structures to transform low-level log information and interaction signals into optimized prompts and machine-readable procedures. Server uses defined neural network architectures, feature sets, and learning algorithms to achieve technical effects such as faster classification, more accurate anomaly detection, and adaptive UI behavior. Terminal, by rendering display modes according to the UI mode and risk information, and User, by executing recommended commands on real communication apparatuses, together realize a complete system that improves response to failures in distributed computing environments.

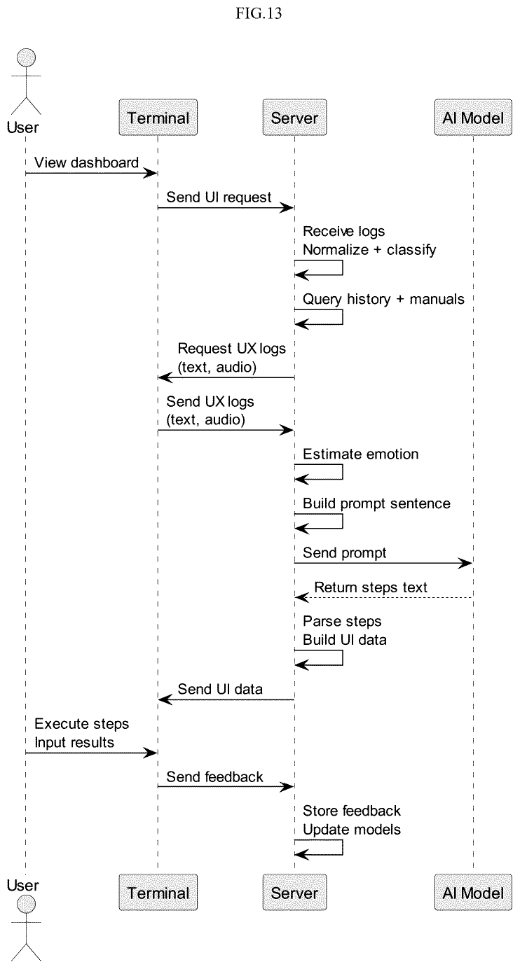

The following describes the processing flow using FIG. 13.

### Step 1:

Server receives raw log messages from communication apparatuses as input. Server listens on a syslog port via a network interface and accepts each log line as a text string such as “<134>Jan 10 10:05:23 routerA % AUTH-3-LOGIN_FAIL: . . . ”. Server parses the text by applying regular expressions to extract fields including timestamp, device identifier, facility, severity, anomaly code, and message body. Server converts these extracted fields into a normalized structured record, for example a JSON-like object, and assigns a unique log identifier. Server outputs the structured record as normalized log data and optionally publishes it to a stream-processing topic for downstream modules.

### Step 2:

Server uses normalized log data as input to an anomaly analysis process. Server passes the message body and extracted fields into a rule-based engine that checks for predefined phrases such as “link down” or “authentication failed” and produces initial anomaly category scores. Server then tokenizes the message body and feeds the tokens into a transformer-based classification model to compute probability values for anomaly categories. Server combines rule-based scores and model probabilities using a weighted sum to calculate a final score per category and selects the category with the highest combined score as an anomaly cause candidate. Server outputs the anomaly cause candidate, including a category label and a short textual explanation linked to the original log identifier.

### Step 3:

Server uses the anomaly cause candidate and the anomaly code as input to a history retrieval routine. Server constructs and executes a query against a history database to retrieve past records having matching anomaly codes and categories. Server groups the retrieved records by procedure pattern, calculates statistical values such as success rates and median recovery times, and ranks the patterns. Server summarizes top-ranked patterns into concise descriptions, forming summary data of past events. Server outputs this summary data, including ordered steps and associated statistics, for use in later processing.

### Step 4:

Server uses the anomaly code and anomaly category as input to a document search process. Server formulates a full-text search query incorporating the anomaly code and keywords from the anomaly cause candidate and submits the query to a search engine indexing apparatus manuals. Server receives a ranked list of document sections and extracts text fragments around top matches. Server applies filters to remove headers, footers, and unrelated lines, and selects sentences that contain imperative verbs or warning phrases. Server aggregates these selected sentences into snippet information that emphasizes countermeasure procedures and cautions. Server outputs the snippet information associated with the current anomaly.

### Step 5:

Terminal uses user interactions with the graphical user interface as input to operation history generation. Terminal records each UI event, including page transitions, button presses, scroll positions, and dialog openings, with event type, component identifier, and timestamp. Terminal buffers these event records locally and periodically sends them to Server as operation history data. Terminal concurrently collects character input information from text fields and feedback forms and, when enabled, captures audio input information from a microphone, segments it into clips, and transmits it. Terminal outputs operation history logs, text inputs, and audio clips as separate but related data streams to Server.

### Step 6:

Server uses operation history logs, text inputs, and audio clips as input to emotion estimation. Server converts operation history into numerical features such as clicks per minute, screen dwell time, and number of revisits, and feeds these features into a trained classification model to infer a stress level. Server tokenizes text inputs and passes them to a transformer-based emotion classification model to obtain emotion labels and confidence scores. Server either transcribes audio clips into text using an automatic speech recognition model or extracts acoustic features and classifies them with an audio emotion model. Server merges stress level, text-based emotions, and audio-based scores via a fusion algorithm to determine a single emotional state label, such as “high-stress and confused” or “calm and confident.” Server outputs the emotional state and links it to the active user session.

### Step 7:

Server takes as input the anomaly cause candidate, summary data of past events, snippet information from manuals, and the emotional state, and generates a prompt sentence. Server selects a template based on the emotional state, for example a detailed template for high-stress users or a concise template for confident users. Server inserts device identifiers, anomaly descriptions, summarized procedures, and key warnings into designated placeholders in the template. Server appends instruction content specifying output format (numbered steps), required command examples, tone, and warning behavior. Server concatenates all elements into a single coherent prompt sentence addressed to a generative AI model. Server outputs this prompt sentence as a text string ready to be sent to the model.

### Step 8:

Server uses the prompt sentence as input to a generative AI model invocation. Server sends the prompt sentence and control parameters such as maximum tokens and temperature to the generative AI model via an API and waits for the response. Server receives a countermeasure procedure text in natural language, typically structured as a numbered list of troubleshooting steps with explanations, commands, and warnings. Server parses this text by splitting on numbering patterns, extracting titles from leading sentences, identifying command-like substrings using pattern rules, and detecting warning phrases via keyword search. Server converts the parsed information into structured countermeasure data, with each step containing step number, description, execution commands, and risk flags. Server outputs this structured countermeasure data for presentation control.

### Step 9:

Server uses the structured countermeasure data and the emotional state as input to user interface data generation. Server selects a display mode, choosing a sequential display format when the emotional state indicates high stress or confusion, and a list display format when the emotional state indicates calm confidence. Server attaches display metadata to each step, such as priority levels and icons for risk flags, and associates relevant manual snippets with corresponding steps. Server packages all this information into a user interface data object, including mode indicators and layout hints. Server outputs the user interface data and transmits it to Terminal over a network.

### Step 10:

Terminal receives user interface data as input to a rendering process. Terminal inspects the display mode and constructs the appropriate component tree in the front-end framework. In sequential mode, Terminal renders a single step per screen, including navigation controls and visually prominent warning messages; in list mode, Terminal renders all steps in a scrollable or collapsible list. Terminal binds completion buttons and feedback fields to event handlers that update local state and prepare data for transmission. Terminal outputs rendered screens to the display and generates user interaction events when the user navigates, marks steps, or enters feedback.

### Step 11:

User uses the rendered countermeasure procedures as input for actual device operations. User reads each step's explanation and example commands, then operates the communication apparatus through external tools such as remote shells or device management interfaces to execute the recommended commands. User observes outcomes, such as successful pings or corrected time synchronization, and returns to the Terminal interface to mark steps as completed and indicate success or failure. User may input textual comments describing anomalies or clarifying context. User outputs operational results and subjective evaluations through the Terminal interface.

### Step 12:

Terminal uses the user's completion actions, success/failure selections, and comments as input to feedback messages. Terminal serializes step execution results, including timestamps and per-step outcomes, along with overall resolution status and user ratings, into a structured feedback payload. Terminal transmits the payload to Server. Terminal outputs this feedback data to the server-side feedback recording process.

### Step 13:

Server uses feedback payloads and associated session metadata as input to feedback recording. Server links each feedback record to the corresponding anomaly cause candidate, generated countermeasure plan, and emotional state history, and writes composite records into history tables in persistent storage. Server organizes this data into learning data sets for anomaly classification, emotion estimation, and prompt template evaluation. Server periodically extracts the learning data and applies machine learning algorithms to update model parameters and adjust prompt templates, then deploys updated models and templates back into the running system. Server outputs improved model weights, updated templates, and refined decision thresholds that affect subsequent anomaly analysis, emotion estimation, prompt sentence generation, and user interface control.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In large-scale information processing infrastructures, operation logs output from various information processing equipment and communication equipment are analyzed to detect failures and performance degradation and to support operators in executing appropriate countermeasures. Conventional failure-handling support systems generally focus on technical indicators and static rule sets: they parse logs, map error messages to known patterns, and present fixed procedure lists or static manuals. These systems treat the operator as a uniform “black box,” without incorporating the operator's emotional state, cognitive load, or comprehension level into the technical decision flow of the support logic or into the way that suggested procedures are generated and displayed.

Such conventional architectures present several technical problems in terms of computer technology itself. First, the log-analysis and guidance-generation pipeline is monolithic and rigid: a log-analysis engine outputs a failure type, and then a fixed template or rule base outputs a textual explanation. The pipeline is not configured to modulate its behavior based on real-time user state signals, and therefore cannot dynamically adapt its data-processing or interaction strategy. Second, even when a generative AI model (for example, a large language model) is added as a replacement for a rule-based text generator, conventional systems typically construct input prompts solely from technical information such as log contents and past failure patterns. They do not integrate structured emotion indicators into the prompt, nor do they learn, from feedback, how prompt structure and UI behavior affect downstream technical outcomes such as success rate, time to resolution, or error rate. As a result, the generative AI model is under-utilized as a computing resource, and its outputs remain insensitive to actual operator conditions.

Third, known systems do not treat multimodal user-side data—such as natural-language text, speech audio, user interface operation logs, and facial images—as first-class signals feeding into the central control logic of the failure-handling engine. At best, such data may be used for separate monitoring or reporting, without closing the loop back into log analysis, prompt construction, and user interface control. Consequently, system behavior is not optimized as a function of both technical context and user context, and the interplay between those contexts is not systematically learned or exploited.

Fourth, feedback from actual failure-handling sessions—such as which steps were executed successfully, how long each step took, and how the operator's emotional state changed during the process—is not typically captured and modeled as structured training data. Existing support tools may log that a case has been closed, but they do not computationally learn how different prompt parameters (for example, number of steps, detail level, jargon constraints) and display formats correlate with success or failure across varying failure types and user states. Thus, the system cannot continuously improve its internal models or parameter settings in a data-driven manner.

Due to these limitations, there is a technical need for a computer-implemented system that integrates multimodal emotion analysis into the core log-analysis and guidance-generation pipeline, dynamically configures generative AI prompts and display strategies based on structured emotion indicators, and continuously adapts those configurations through machine learning on feedback. Such a system should not simply display different wording, but should reconfigure concrete computational processes—such as prompt sentence generation, step segmentation, and content filtering—so that the underlying computing architecture itself is optimized for both technical conditions and user state. This improves the functioning of the computer system as a whole by reducing mis-operations, lowering cognitive overload, and shortening the time to technical resolution through adaptive, learned control of the generative AI model and the user interface layer.

The specific processing by the specific processing unit 290 of the data processing device 12 in Application Example 2 is realized by the following means.

The present invention provides a server comprising a processor configured to execute a series of operations including: recording past failure-handling histories in a history storage unit; collecting operation logs output from information processing equipment and communication equipment and structuring the operation logs as time-series operation indicator data in a log collection unit; storing technical document information in an information storage unit; detecting abnormal events in the operation logs and analyzing log text related to the abnormal events by using at least one of natural language processing and machine learning in order to specify a failure type and a candidate failure cause, and extracting a candidate countermeasure method based on the failure type, the candidate failure cause, the technical document information, and the past failure-handling histories in a failure analysis unit; calculating a user emotion state indicator in an emotion analysis unit by receiving as input at least one of text data, audio data, operation history data, and image data obtained from a user terminal and by applying at least one of natural language processing, acoustic signal processing, behavioral analysis, and image analysis; generating, in a prompt generation unit, a prompt sentence for input to a generative AI model based on the failure type, the candidate failure cause, the candidate countermeasure method, the past failure-handling histories, and the user emotion state indicator, and inputting the prompt sentence to the generative AI model to obtain failure-handling procedure information; controlling, in a display control unit, display of the failure-handling procedure information by dynamically adjusting, according to the user emotion state indicator, a number of presentation steps, a level of detail of explanations, and a degree of use of technical terms and by outputting the failure-handling procedure information to the user terminal; and storing, as feedback information, operation results performed by the user in accordance with the failure-handling procedure information and changes in the user emotion state indicator, and updating, in a learning unit, at least one of conditions for generating the prompt sentence and weighting of features in the emotion analysis unit based on the feedback information. This enables the computer system to adaptively control both the generative AI model and the user interface in response to jointly modeled technical context and user emotion state, to optimize prompt sentences and display strategies through learned feedback, and thereby to improve the technical performance of the failure-handling support pipeline, including reduction of mis-operations, decrease of time to resolution, and enhancement of robustness in large-scale log analysis and guidance generation.

The term “history storage unit” refers to a storage-related functional block implemented by hardware, software, or a combination thereof, which is configured to store and manage past failure-handling histories including, for example, failure types, causes, countermeasures, results, and associated metadata.

The term “operation logs” refers to log data output from information processing equipment or communication equipment, indicating operational states, resource usage, events, warnings, and errors, and including at least time information, device identification information, and message content.

The term “information processing equipment” refers to an electronic computing apparatus, such as a server device, client device, or storage device, which executes programs and processes data.

The term “communication equipment” refers to a hardware device that performs data communication, such as a router, switch, gateway, or other network device.

The term “time-series operation indicator data” refers to structured data representing numerical or categorical operation indicators, such as CPU usage, memory usage, disk utilization, or error counts, associated with timestamps and arranged in chronological order.

The term “log collection unit” refers to a functional block that receives operation logs from information processing equipment or communication equipment, and converts, filters, and structures the logs into time-series operation indicator data.

The term “technical document information” refers to document data describing specifications, error codes, configuration procedures, and troubleshooting steps for equipment or software, such as manuals, knowledge-base articles, and reference guides.

The term “information storage unit” refers to a storage-related functional block that stores technical document information and provides access to such information for analysis or reference.

The term “abnormal event” refers to an event detected from operation logs in which at least one operation indicator deviates from a predetermined normal range or threshold, or in which error messages or warning messages indicating a failure or performance degradation appear.

The term “failure analysis unit” refers to a functional block configured to detect abnormal events from operation logs, analyze log text by using natural language processing and machine learning, specify a failure type and a candidate failure cause, and extract a candidate countermeasure method.

The term “natural language processing” refers to a class of techniques executed by a processor to analyze and process text data expressed in human language, including, for example, tokenization, syntactic analysis, semantic analysis, classification, and embedding.

The term “machine learning” refers to a class of data-processing techniques in which a processor applies a trained model, obtained through training on example data, to infer labels, scores, or other outputs from input data.

The term “failure type” refers to a classification label indicating a category of a failure, such as CPU overload, disk capacity shortage, memory exhaustion, or network congestion.

The term “candidate failure cause” refers to an inferred cause or cause candidate of a failure, estimated from operation logs, technical document information, and past failure-handling histories.

The term “candidate countermeasure method” refers to a method or procedure candidate for handling or resolving a failure, extracted from past failure-handling histories and technical document information.

The term “user terminal” refers to an information processing apparatus operated by a user, such as a mobile terminal, tablet terminal, or personal computer, configured to transmit input data to a server and display information received from the server.

The term “emotion analysis unit” refers to a functional block configured to calculate a user emotion state indicator based on input data including at least one of user text data, audio data, operation history data, and image data.

The term “text data” refers to character-string information expressed in natural language and input by a user through a user terminal, including, for example, comments, descriptions, and messages.

The term “audio data” refers to digital data representing a user's speech captured by a microphone and subjected to sampling and encoding.

The term “operation history data” refers to data representing a history of user interface operations performed on a user terminal, including, for example, screen transitions, button selections, error confirmations, and help invocations, each associated with at least a timestamp.

The term “image data” refers to digital data representing images or video frames captured by an imaging device of a user terminal, including at least a region containing a user's face or upper body.

The term “acoustic signal processing” refers to techniques executed by a processor to analyze audio data, including, for example, extraction of spectral features, prosodic features, and other acoustic parameters.

The term “behavioral analysis” refers to techniques executed by a processor to analyze operation history data, including, for example, calculation of screen dwell times, operation frequencies, error occurrences, and help usage.

The term “image analysis” refers to techniques executed by a processor to analyze image data, including, for example, object detection, face detection, and facial expression recognition.

The term “user emotion state indicator” refers to evaluation information representing a psychological state of a user, including at least one of a stress level, a comprehension level, and an urgency level, expressed as numerical values or categorical labels.

The term “prompt generation unit” refers to a functional block configured to generate a prompt sentence for a generative AI model based on a failure type, a candidate failure cause, a candidate countermeasure method, past failure-handling histories, and a user emotion state indicator, and to input the prompt sentence to the generative AI model.

The term “prompt sentence” refers to a text sequence that specifies input conditions, context information, and output requirements for a generative AI model, including at least technical incident information and user emotion state information.

The term “generative AI model” refers to an artificial intelligence model trained by machine learning to generate output content, such as natural-language text, from an input prompt sentence, and including, for example, a large language model.

The term “failure-handling procedure information” refers to information output from the generative AI model that describes, in natural language, specific steps and cautions for handling or resolving a detected failure.

The term “display control unit” refers to a functional block configured to control display of failure-handling procedure information on a user terminal, including dynamic adjustment of a number of steps, a level of detail of explanations, and a degree of use of technical terms based on a user emotion state indicator.

The term “feedback information” refers to information representing results of operations performed by a user in accordance with failure-handling procedure information, including success or failure, operation time, user evaluations, and changes in user emotion state indicators.

The term “learning unit” refers to a functional block configured to update, using feedback information, at least conditions for generating a prompt sentence and weighting of features in an emotion analysis unit by applying machine learning or parameter updating techniques.

The term “degree of use of technical terms” refers to a parameter or control state indicating a relative frequency or intensity of inclusion of specialized technical vocabulary in displayed or generated text, and is used to determine whether to simplify or explain such vocabulary.

The term “number of presentation steps” refers to the count or segmentation of discrete procedure steps that are presented to a user as part of failure-handling procedure information.

The term “level of detail of explanations” refers to a parameter indicating how finely or coarsely a procedure or concept is described, including, for example, whether to include sub-steps, background explanations, and detailed options in failure-handling procedure information.

In one embodiment, a server implements the core processing of the system as computer-executable programs running on general-purpose hardware. The server includes at least one central processing unit (CPU), a main memory, a non-volatile storage device, and a network interface. The server executes an operating system, such as a server-oriented operating system, and application software written in a scripting language such as Python. The server further executes a log collection framework (for example, a syslog-compatible log receiver and a log aggregation daemon), a database management system such as a relational database, and libraries for numerical computation, machine learning, deep learning, and natural language processing, such as numerical array libraries, classical machine learning libraries, deep learning frameworks, and transformer-based natural language processing libraries. The server may additionally access a generative AI model through a local inference engine or through an external application programming interface.

Terminal operates as a user-side device and is implemented using a mobile terminal, tablet terminal, or personal computer. Terminal includes a display, an input device such as a touch panel or keyboard, a microphone, a camera, and a communication interface. Terminal executes a client application or a web browser to present graphical user interfaces and communicate with the server via a network. Terminal records user inputs, including text, audio, operation history, and image data, and transmits such data to the server as structured messages.

User operates the terminal to inspect failure events, to read suggested procedures, and to provide feedback. User enters free-form textual descriptions, utters spoken explanations, manipulates user interface components during failure-handling, and optionally allows the terminal to capture facial images for emotion analysis.

In a representative configuration, the server collects operation logs from multiple information processing equipment and communication equipment via a logging protocol. The server runs a log receiver to accept text-based log messages and passes them to a log aggregation process. The server configures this aggregation process with pattern-matching filters expressed as regular expressions. The log aggregation process extracts operation indicators such as CPU usage, memory usage, disk utilization, packet error counts, and connection error counts from raw text, and structures them as records in a time-series data format with fields including timestamps, device identifiers, indicator types, and indicator values. The server stores these records into a relational database table, and additionally stores the original log messages or normalized text in associated tables.

The server performs statistical analysis on the time-series operation indicator data. The server loads recent sequences of indicator values into numerical arrays, computes moving averages, standard deviations, and rate-of-change values over sliding windows, and compares these values against preconfigured or learned thresholds. The server marks sequences that exceed thresholds or exhibit anomalous patterns as abnormal events. For example, when the CPU usage for a particular device remains above ninety-five percent for more than a predetermined duration, the server records an abnormal event entry including the device identifier, start time, end time, and peak usage. This use of numerical time-series analysis improves detection of failures compared to purely rule-based string matching because the server can detect subtle temporal patterns that would be difficult to specify with static if-then rules, and can do so at machine scale and speed.

The server performs log text analysis using a deep neural network architecture. The server tokenizes log message text into subword tokens using a transformer-based tokenizer, converts the tokens into integer indices, and inputs the indices into a multi-layer transformer encoder. The transformer includes multiple self-attention layers and feed-forward layers, each with trainable weight matrices. The server obtains, from the transformer, a contextual embedding vector representing the semantics of each log message or of a concatenated log context. The server may fine-tune the transformer encoder on labeled log data, using a cross-entropy loss function over failure-type labels and optimizing weights using stochastic gradient descent or a variant such as Adam. The server then uses either the final-layer embedding corresponding to a special classification token, or an averaged sequence embedding, as input to a downstream classifier such as a logistic regression model, support vector machine, or gradient boosting tree model. This classifier outputs a probability distribution over failure types. By using embeddings learned from large corpora and then fine-tuning them on log-specific labels, the server achieves higher classification accuracy and robustness to message variation than conventional keyword-matching approaches.

The server accesses past failure-handling histories stored in a history storage unit. Each history record contains at least a failure type, a textual description of the cause, a description of the successful countermeasure, a result flag, and timing information. The server represents these history texts as vectors, using the same transformer-based embedding method, and stores the vectors in the database or in an auxiliary feature store. For a newly detected abnormal event, the server retrieves similar past cases by computing cosine similarity between the embedded representation of the current log context and stored embeddings of past incidents. The server selects the most similar past incidents and extracts their cause summaries and countermeasure summaries. This similarity-based retrieval utilizes vector-space representations learned by the neural network, rather than relying solely on exact keyword overlap, and thereby improves the coverage and relevance of retrieved cases.

The server performs emotion analysis on multimodal data received from the terminal. For text data, the server tokenizes the user's description and uses a fine-tuned transformer-based classifier to output probabilities over emotion categories such as anxiety, confusion, anger, and calmness. The server maps these category probabilities into numerical scores, for example by weighting negative emotions to derive a stress score, and by detecting explicit expressions of misunderstanding to derive a comprehension score. For audio data, the server uses an audio processing library to compute features such as Mel-frequency cepstral coefficients, pitch contours, energy envelopes, and speaking rate. The server inputs these features into a deep neural network implemented using a sequence model, such as a convolutional network followed by a recurrent network or a temporal convolutional network. The network has been trained on labeled emotional speech data by minimizing a loss function such as categorical cross-entropy, and outputs class probabilities or continuous scores indicating tension, anger, and stress.

For operation history data, the server aggregates signals such as the number of screen transitions per unit time, dwell time on each screen, number of input validation errors, backtracking patterns, and help page accesses. The server constructs a feature vector comprising such behavioral indicators and inputs it to a classical machine learning model, such as a random forest regressor or a gradient boosting regressor, trained to estimate confusion level and operation load. For image data, the server uses an image processing library to detect and crop the user's face, normalizes the face region, and then applies a convolutional neural network trained on facial expression datasets. The network outputs probabilities over facial expression classes such as neutral, happiness, sadness, anger, and surprise. The server then aggregates text-based, audio-based, behavioral, and image-based features into a unified feature vector, and feeds this vector into an ensemble model such as a gradient boosting model or a shallow neural network trained to output normalized emotion state indicators, including stress level, comprehension level, and urgency level.

By combining multiple modalities and using distinct models tuned to each modality, the server reduces the error of emotion estimation compared with single-modality or rule-based systems. For example, when text and audio provide conflicting signals, the ensemble model can weight modalities differently, based on training data, to produce a more accurate overall state indicator. This multimodal fusion is performed by explicit feature concatenation and model-based weighting rather than by ad hoc rules, which permits systematic improvement through further training on additional feedback data.

The server generates a prompt sentence for a generative AI model by explicitly incorporating both the technical analysis result and the user's emotion state indicator. The server assembles a data structure containing: a device identifier, aggregated operation indicators for the event, the classified failure type, one or more candidate failure causes, a summary of relevant past countermeasures, and the current emotion state indicators (stress, comprehension, urgency). The server selects one of multiple prompt templates according to predetermined rules or a learned policy. For example, when the stress level exceeds a first threshold and the comprehension level is below a second threshold, the server selects a “simplified” template that restricts the maximum number of steps and requires non-technical wording. When the stress level is low and the comprehension level is high, the server selects a “technical” template that allows more steps and technical terminology.

The server performs string processing to embed the above mentioned data fields into placeholder positions in the selected template. The server thus forms a concrete prompt sentence that instructs the generative AI model regarding desired output structure, step limitations, language style, and explanation level. One example of a prompt sentence generated by the server is as follows:

“You are a generative AI model specialized in data center operations support.

Current incident: On Server-01, CPU usage has stayed above 95% for the last 15 minutes.

Log analysis indicates that process ID 12345 (Application X) is causing abnormal CPU load.

Past similar incidents were resolved by stopping unnecessary batch jobs and changing load-balancing settings.

Current operator state: stress is high, comprehension is low, urgency is high.

Based on this,
1. Provide an immediate recovery procedure in at most 3 steps.
2. Use simple, concrete instructions such as ‘open this screen’ or ‘run this command’.
3. Avoid technical jargon as much as possible, and when necessary, provide a short explanation.
4. After the steps, list 3-5 short cautions as bullet points.”

The server transmits the prompt sentence to a generative AI model implemented as a large language model, which may be hosted on the same hardware or accessed via an external service. The generative AI model internally consists of a multi-layer transformer decoder or encoder-decoder architecture, trained with next-token prediction loss on large text corpora and optionally fine-tuned on domain-specific operation procedures. Although the internal weights of the generative AI model are not necessarily modified by the server during normal inference, the server modifies the effective behavior of the generative AI model by constructing the prompt sentence in a way that encodes system state and desired constraints. This prompt-driven control is not equivalent to a human rewriting a manual, because the server algorithmically builds the prompt based on structured features from log analysis and emotion estimation, in real time, at scale, and with systematic variation according to learned models.

The server receives natural-language output from the generative AI model, including a numbered list of steps and caution notes. The server parses the output text by detecting markers such as “Step 1,” numeric prefixes, and bullet characters, and segments the text into discrete procedure steps and caution lists. The server creates structured procedure objects in its memory, with fields for step order, summary title, detailed instruction text, and associated cautions. The server stores these objects in the database along with a reference to the corresponding prompt sentence and abnormal event. By converting free-text output into a structured representation, the server can further manipulate, filter, or merge steps and can apply additional logic such as removing redundant actions or splitting overly long steps, based on predetermined rules.

The server generates display control instructions to adapt the presentation of the failure-handling procedure information on the terminal. When the emotion state indicates high stress and low comprehension, the server instructs the terminal to display only the current step in a prominent card layout, hide or collapse future steps, and optionally shorten explanation text by filtering out non-essential background information. When the emotion state indicates low stress and high comprehension, the server instructs the terminal to display all steps in a list format, with full technical descriptions and command examples. The server additionally marks technical terms in the step texts by scanning for entries present in a technical vocabulary table. The server attaches metadata indicating that the terminal should show explanatory tooltips or pop-up windows when a user interacts with these technical terms. Terminal receives the structured procedure objects and display control instructions, and renders them as a user interface using a graphical toolkit or web technologies. Terminal implements an event handling mechanism for user actions such as tapping “Done” or “I do not understand.” Terminal sends these user actions back to the server as feedback events with associated identifiers and timestamps. Terminal may also periodically transmit updated emotion-related data, enabling the server to detect changes in stress or comprehension during the procedure. This closed feedback loop allows the server to adapt prompts and displays not only at the initial step but also dynamically, for example by regenerating a clarifying step when the user repeatedly indicates difficulty.

The server records feedback information in the database. For each step and each session, the server stores whether the step was executed successfully, how long it took from presentation to completion, whether the user requested additional explanation, and how the emotion state indicators changed. The server then periodically performs training of policy models that map from input conditions (failure type, initial emotion state indicators, prompt template parameters, display parameters) to outcome metrics (success probability, time to resolution, user satisfaction scores). The server uses supervised learning methods such as gradient boosting trees or neural networks. The server defines loss functions to reward configurations that yield high success and low resolution time, and uses training algorithms to update model parameters. The server then uses the trained models at runtime to select prompt templates, set the maximum number of steps, and adjust explanation detail levels for future incidents.

By incorporating feedback-driven learning, the server continuously improves the mapping from system states to generative AI prompts and interface configurations. This yields technical effects beyond simple automation. For example, the server can reduce the average number of clarification steps required, thereby lowering network traffic associated with repeated prompt exchanges; can reduce the cognitive workload on the operator, thereby lowering the probability of mis-operations that would trigger further failures and log volume; and can maintain throughput even as the scale of managed equipment increases. In addition, the modeling of emotion state as numerical feature vectors and their integration into the log analysis and prompt generation pipeline is performed by explicit computational steps, executed by the server's processors, which change how the underlying computing system allocates resources and structures data, rather than merely changing display wording.

In some embodiments, the server uses a local generative AI model running under a deep learning framework on hardware with graphical processing units or specialized accelerators. The server can adjust token generation parameters, such as temperature and maximum token count, based on failure criticality and operator state, as part of the prompt generation and inference call. In other embodiments, the server calls an external generative AI service via an encrypted network protocol, and the system can be configured to cache prompts and responses to reduce bandwidth and latency for recurring failure patterns. The use of structured prompt construction and response post-processing allows the server to decouple internal machine representations from external model interfaces, which improves maintainability and portability of the system.

In an alternative embodiment, the server uses a different deep neural network architecture for emotion analysis, such as a multi-modal transformer that jointly processes text tokens, audio spectrogram patches, and image patches. The server trains such a model using a multi-task loss that includes cross-entropy components for emotion categories and regression components for stress and comprehension scores. This architecture can capture cross-modal correlations more directly than a simple ensemble of separate models, and can therefore improve emotion estimation accuracy. The server can further use transfer learning techniques to adapt the model to specific operational environments by fine-tuning on feedback collected from operators in that environment.

In yet another embodiment, the server maintains multiple generative AI models tuned for different purposes, such as a concise-explanation model and a detailed-explanation model. The server selects which model to use, or whether to combine outputs from multiple models, based on both failure characteristics and emotion state indicators. For example, when urgency is very high, the server may prioritize a model that tends to produce shorter, more action-oriented steps, even if it omits some background explanation. By maintaining explicit model-selection logic and training data that link model choice to outcome metrics, the server further increases the flexibility and technical efficiency of the failure-handling support pipeline.

In all of these embodiments, the server, terminal, and user cooperate through technically specific data structures, algorithms, and neural network models. The server does not merely mimic a human operator's judgment; instead, the server implements a specialized, adaptive computation pipeline that integrates numerical time-series analysis, vector-based text analysis, multimodal emotion estimation, structured prompt sentence generation, generative AI model control, dynamic user interface rendering, and feedback-based learning. This pipeline, implemented on a programmed computer system, improves the functioning of the computer itself in the context of large-scale log analysis and operations support by increasing detection accuracy, reducing manual rule maintenance, lowering communication overhead, and enabling stable, scalable handling of failures with behavior tailored to both system conditions and user state.

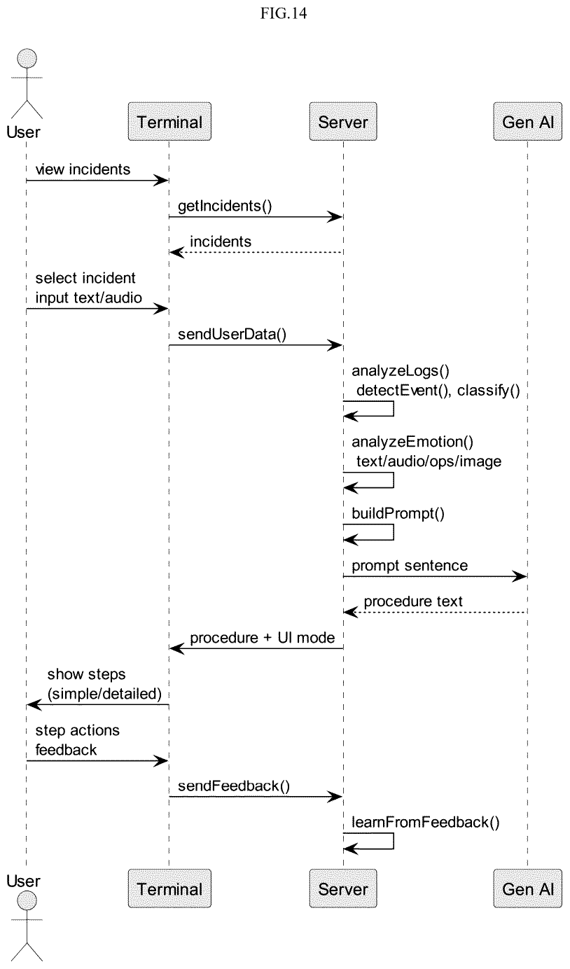

The following describes the processing flow using FIG. 14.

### Step 1:

Server receives operation logs as input from multiple information processing equipment and communication equipment. Server runs a log receiver to accept text-based log messages over a logging protocol and forwards these messages to a log aggregation process. Server applies regular-expression filters to each log line to extract operation indicators such as CPU usage, memory usage, disk utilization, packet error counts, and connection error counts, and structures them into time-series records with fields including timestamps, device identifiers, indicator types, and indicator values. Server writes these structured records as output into a relational database table, and also stores the raw log text in an associated table for later text analysis.

### Step 2:

Server reads, as input, recent time-series operation indicator records for each device from the database. Server loads indicator values into numerical arrays and performs data computations, including calculation of moving averages, standard deviations, rate-of-change values, and comparisons to predefined or learned thresholds. Based on these computations, Server detects abnormal patterns such as persistent high CPU usage or sudden spikes in error counts and marks these as abnormal events. Server stores abnormal event entries with attributes such as device identifier, start time, end time, peak value, and indicator type as output in an abnormal event table for subsequent processing.

### Step 3:

Server receives, as input, an abnormal event identifier and retrieves the corresponding detailed log messages from the database for a time window around the event. Server tokenizes each log message using a transformer-based tokenizer and converts tokens into integer indices. Server feeds these indices into a transformer encoder to compute contextual embedding vectors representing the semantics of each message or of concatenated log contexts. Server applies a trained classifier to these embeddings to compute probability distributions over failure type labels. Server outputs, for each abnormal event, a classified failure type and a set of candidate failure causes, and stores these results in a failure analysis table.

### Step 4:

Server reads, as input, the classified failure type associated with an abnormal event and queries a history storage unit containing past failure-handling records. Server represents textual descriptions of past incidents and countermeasures as embedding vectors using the same transformer encoder, if not already stored. Server computes similarity metrics, such as cosine similarity, between the current event embedding and stored incident embeddings. Based on these calculations, Server retrieves the most similar past cases and extracts cause summaries and countermeasure summaries. Server outputs, as event-related data, a set of candidate countermeasure methods and associated metadata, which are stored in association with the current abnormal event.

### Step 5:

Terminal receives, as input, a list of abnormal events and related summaries from Server, and displays an incident list to User. User selects a particular incident on Terminal, causing Terminal to request detailed support information from Server. User enters free-form text describing the situation and feelings into a text input field, and Terminal captures this text string as input. User optionally presses a record button to provide a spoken description, and Terminal records and encodes the audio data. Terminal also logs user interface operations such as button presses, screen transitions, and help invocations, and, with User consent, captures facial images using the camera. Terminal sends, as output, structured data including text data, audio data, operation history data, and image data to Server for emotion analysis.

### Step 6:

Server receives, as input, user text data from Terminal. Server tokenizes the text and feeds the tokenized representation into a fine-tuned transformer-based emotion classifier. Server computes probabilities for emotion categories such as anxiety, confusion, anger, and calmness, and uses these probabilities to calculate numerical scores, including a text-based stress score and a text-based comprehension score. Server outputs these scores as part of an intermediate emotion feature set for the current user and incident.

### Step 7:

Server receives, as input, user audio data from Terminal. Server uses an audio processing library to compute features such as Mel-frequency cepstral coefficients, pitch contours, energy levels, and speaking rate. Server inputs these feature vectors into a trained deep neural network for speech emotion recognition. The network performs forward propagation and outputs scores or probabilities associated with emotional dimensions such as tension, anger, and stress. Server normalizes these outputs and adds them to the intermediate emotion feature set for the user as additional audio-based features.

### Step 8:

Server receives, as input, operation history data from Terminal. Server aggregates UI event records for the current session and computes behavioral features including the number of screen transitions per unit time, the average dwell time on each screen, the number of form validation errors, the number of back-navigation events, and the number of help-page openings. Server inputs these features into a trained machine learning model, such as a random forest regressor or gradient boosting regressor, which outputs estimated values for confusion level and operation load level. Server appends these estimated values to the intermediate emotion feature set as behavioral features for the user.

### Step 9:

Server receives, as input, image data containing User's face from Terminal. Server applies an image processing library to detect and crop the face region, then normalizes the crop (for example, by resizing and standardizing pixel values). Server inputs the normalized face image into a trained convolutional neural network for facial expression recognition. The network outputs probabilities for facial expression classes such as neutral, happiness, sadness, and anger. Server converts these probabilities into expression-based emotion metrics and appends them to the intermediate emotion feature set as image-based features.

### Step 10:

Server aggregates, as input, all intermediate emotion features for a given user and incident, including text-based scores, audio-based scores, behavioral indicators, and image-based metrics. Server constructs a unified feature vector and inputs it into an ensemble model, such as a gradient boosting model or shallow neural network, trained to predict overall emotion state indicators. Server executes the model to compute numerical outputs for stress level, comprehension level, and urgency level. Server stores these emotion state indicators in an emotion state table and outputs them for use by other processing units, linking them with the corresponding abnormal event and user.

### Step 11:

Server receives, as input, the failure type, candidate failure causes, candidate countermeasure methods, past failure-handling history associated with the event, and the computed emotion state indicators. Server selects a prompt template by applying rules or a learned policy that maps combinations of stress, comprehension, and urgency levels to template identifiers. Server then performs string substitution by inserting event-specific and user-specific variables, such as server name, process identifier, failure type, past case summaries, stress level, and comprehension level, into placeholder fields within the selected template. Based on these data-processing steps, Server generates a concrete prompt sentence that includes explicit instructions for the generative AI model regarding number of steps, wording style, and explanation requirements. Server outputs this prompt sentence for input to the generative AI model and stores it in a prompt history table.

### Step 12:

Server sends, as input, the generated prompt sentence to a generative AI model via a local inference interface or an external API. Server provides additional parameters, such as maximum token length and temperature, to control text generation behavior. The generative AI model internally computes output tokens using its transformer-based architecture. Server receives, as output, a natural-language response that describes suggested failure-handling steps and associated cautions. Server parses the response by scanning for step markers, numeric prefixes, or bullet points, and splits the text into discrete step segments and a caution list. Server creates structured procedure objects by extracting, for each step, a step order, a short title, and a detailed description, and associates the caution items with relevant steps or with the overall procedure. Server stores these structured procedure objects in the database and outputs them as failure-handling procedure information to be sent to Terminal.

### Step 13:

Terminal receives, as input, the structured failure-handling procedure information and emotion state indicators from Server. Terminal evaluates the emotion state indicators to determine a display mode, such as a simplified mode for high-stress and low-comprehension states or a detailed mode for low-stress and high-comprehension states. Terminal, based on this determination, selects UI components and layout rules. In a simplified mode, Terminal displays only the current step in an emphasized card and collapses other steps behind expandable sections. In a detailed mode, Terminal presents all steps in a scrollable list with full explanatory text. Terminal also scans step text for technical terms provided by Server and overlays information icons that, when tapped, open explanatory pop-ups. Terminal outputs a rendered screen containing these elements and provides interactive buttons, such as “Done,” “I do not understand,” and “Skip,” as part of the displayed procedure.

### Step 14:

User receives, as input, the displayed failure-handling procedure on Terminal and performs physical or logical operations on the target information processing equipment or communication equipment in accordance with the instructions. User marks progress by tapping buttons on Terminal, such as “Done” when a step is completed or “I do not understand” when a step is unclear, and may enter additional comments in a text field. User continues to interact with Terminal while executing the procedural steps until the failure is resolved or until User decides to stop the process. Terminal collects these user actions and comments as feedback data and prepares this data as output to be transmitted to Server.

### Step 15:

Terminal sends, as input to Server, feedback data including step identifiers, completion flags, timestamps, user comments, and optional updated emotion-related measurements captured during the procedure. Terminal may also send the results of a post-procedure survey completed by User, including ratings for usefulness, clarity, and satisfaction. Terminal transmits this structured feedback information over the network as messages associated with the corresponding abnormal event and prompt history entry.

### Step 16:

Server receives, as input, the feedback data from Terminal and associates it with the corresponding abnormal event, prompt sentence, and generated procedure records stored in the database. Server writes this feedback into a feedback table, including fields such as success or failure of each step, time taken, number of clarification requests, user satisfaction scores, and changes in emotion state indicators before and after the procedure. Server periodically reads accumulated feedback, prompt history, emotion state data, and outcome metrics to construct training datasets. Server performs machine learning by feeding these datasets into models that map configuration features (such as prompt template choice, step count, explanation detail level, and display mode) and context features (such as failure type and initial emotion state) to targets like success probability and time to resolution. Server calculates loss values based on prediction errors and updates model parameters using optimization algorithms. Server then updates internal configuration rules or model-based decision logic for prompt generation and display control. Server outputs updated configuration parameters and model weights, which will be applied in future executions of emotion analysis, prompt sentence generation, and display control, thereby closing the adaptive learning loop of the system.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

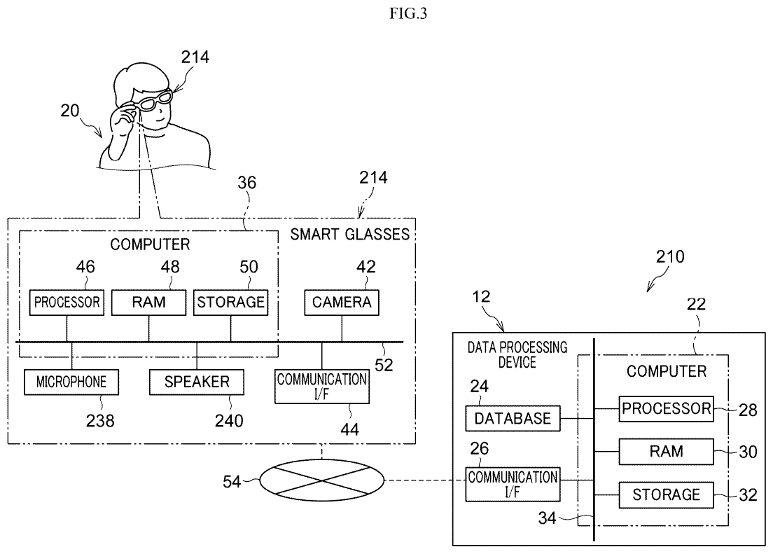

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication IF 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication IF 26 is connected to a network 54. Examples of the network 54 include a Wide Area Network (WAN) and/or a local area network (LAN).

The smart glasses 214 include a computer 36, a microphone 238, a speaker 240, a camera 42, and a communication IF 44. The computer 36 includes a processor 46, RAM 48, and storage 50. The processor 46, the RAM 48, and the storage 50 are connected to a bus 52. The microphone 238, the speaker 240, the camera 42, and the communication IF 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication IF 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

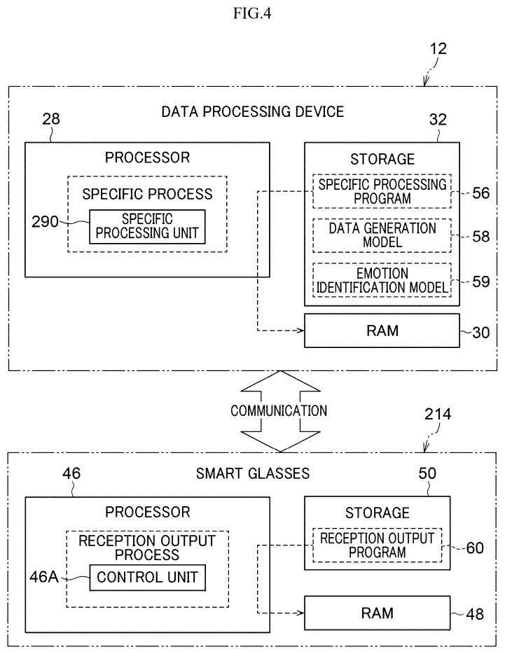

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

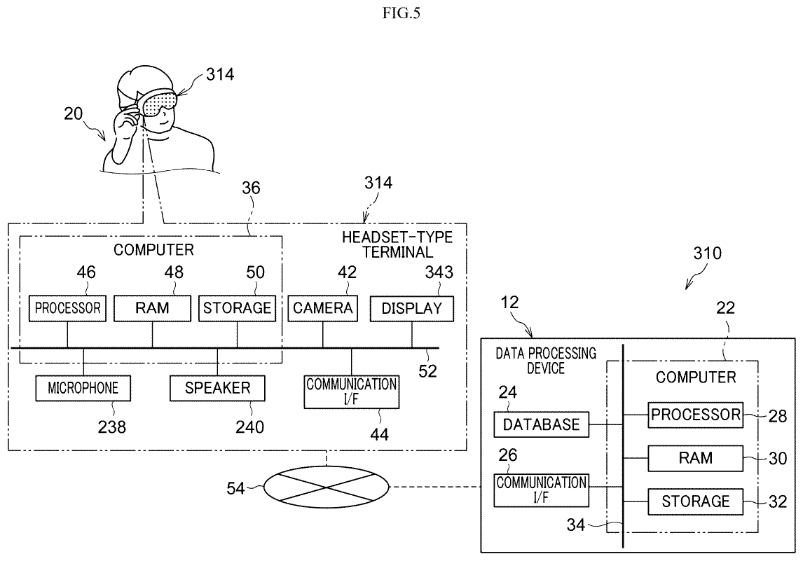

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication IF 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication IF 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication IF 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

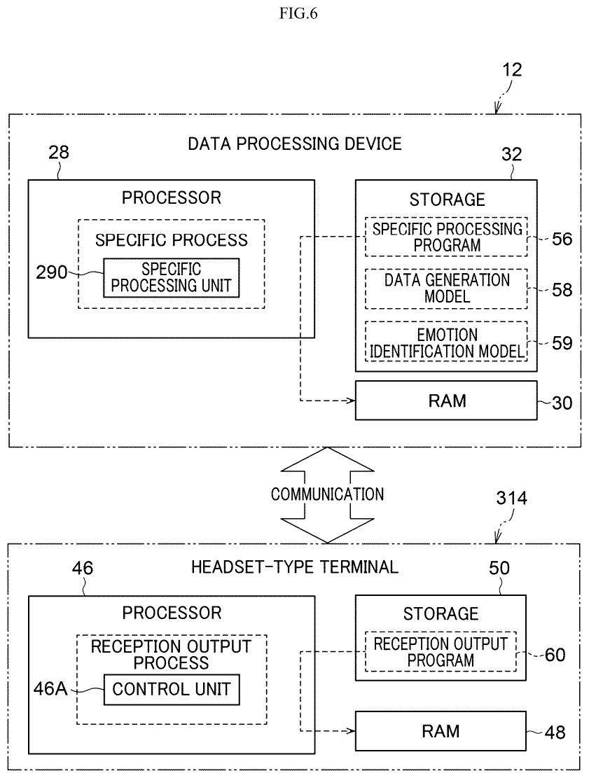

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

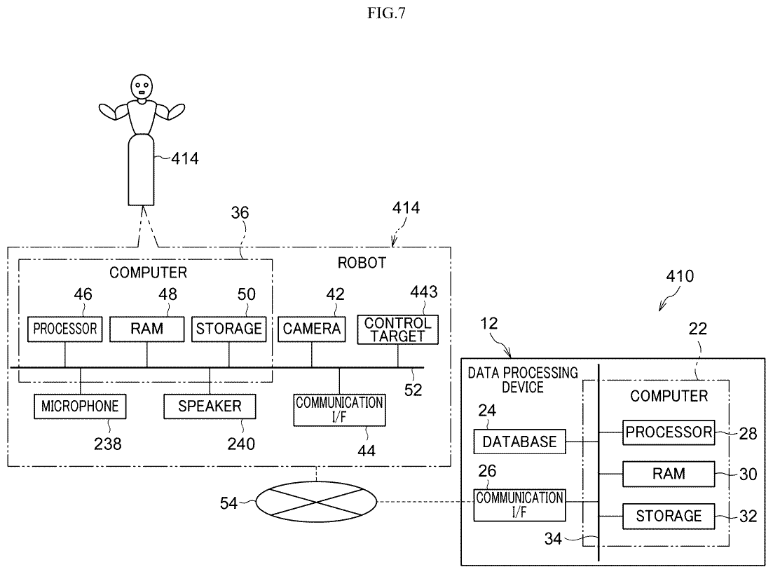

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication IF 26 is connected to a network 54. Examples of the network 54 include a Wide Area Network (WAN) and/or a local area network (LAN).

The robot 414 includes a computer 36, a microphone 238, a speaker 240, a camera 42, a communication IF 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

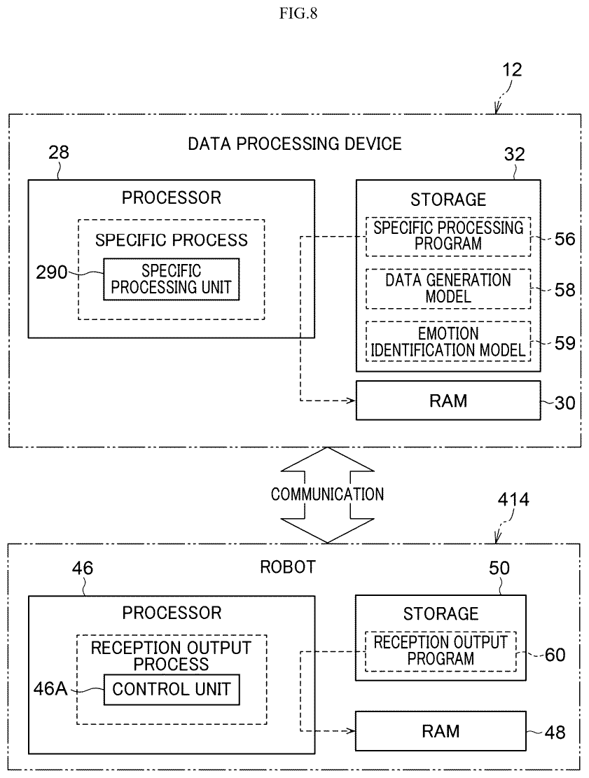

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

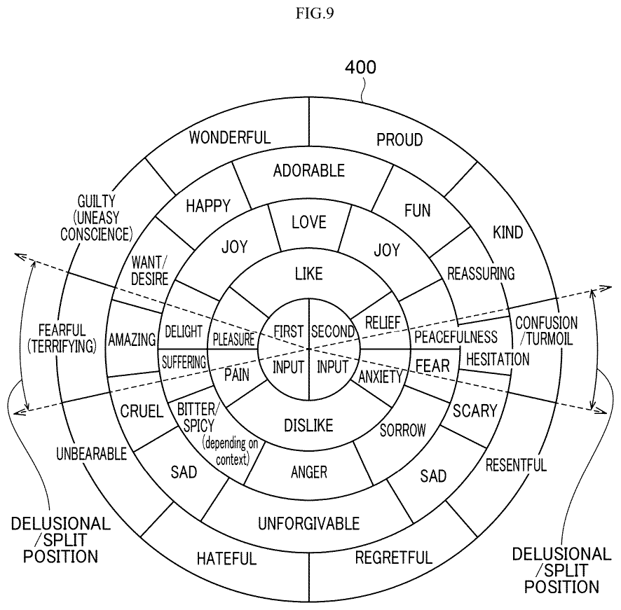

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

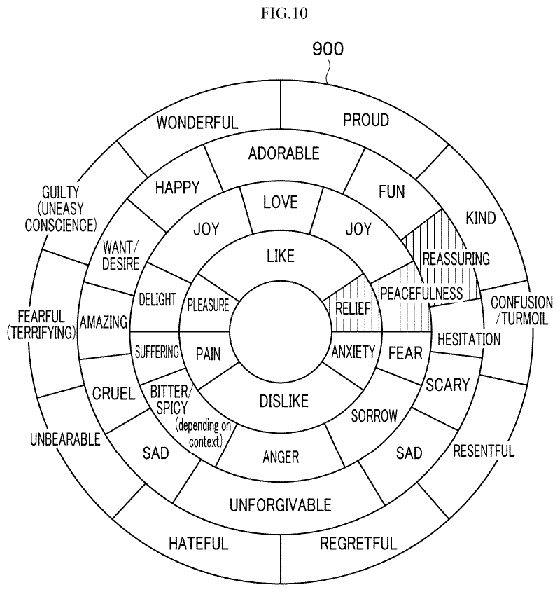

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
store and search past failure-handling information as structured data, as a history information recording unit,
receive operation monitoring information transmitted from an information processing apparatus, convert the operation monitoring information into unified-format data, and store the unified-format data, as an operation information collection unit,
store technical document information as indexable data enabling full-text search and extract related technical information, as a reference information search unit,
classify a failure event and estimate one or more candidate causes of the failure event based on the operation monitoring information and the history information, as a machine learning processing unit,
generate an instruction sentence to be input to a generative AI model based on the candidate causes estimated by the machine learning processing unit and the technical document information acquired from the reference information search unit, input the instruction sentence to the generative AI model, acquire countermeasure procedure information expressed in natural language from the generative AI model, and structure and store the countermeasure procedure information, as an analysis unit,
present summary information of the failure event and the countermeasure procedure information to a user terminal, acquire evaluation information regarding execution results of the countermeasure procedure information, and register the evaluation information in the history information recording unit, as a user interface unit, and
update training data of the machine learning processing unit and update generation conditions of the instruction sentence to be input to the generative AI model based on the acquired evaluation information, as a learning control unit.

### (Supplementary 2)

The system according to supplementary 1,
wherein the processor is configured to
generate feature information including time-series pattern information and message content information extracted from the operation monitoring information, estimate a type and a priority of the failure event based on the feature information, calculate similarity between the failure event and past failure events stored in the history information recording unit, and control contents of the technical document information acquired from the reference information search unit and contents of the instruction sentence to be input to the generative AI model so as to be selectively changed based on the similarity.

### (Supplementary 3)

The system according to supplementary 1,
wherein the processor is configured to
generate the instruction sentence including context information obtained by integrating the operation monitoring information, past failure event information acquired from the history information recording unit, and technical document information acquired from the reference information search unit, input the instruction sentence to the generative AI model to cause the generative AI model to generate, in natural language, a proposal including countermeasure information in a stepwise procedure format executable by a user and including risk information, cause the user interface unit to display the proposal on a step-by-step basis, and
acquire effectiveness evaluation information for each step and provide the effectiveness evaluation information to the learning control unit for improving accuracy of future generation of the countermeasure procedure information.

### Application Example 1

### (Supplementary 1)

A system comprising a processor,
wherein the processor is configured to
record historical failure-response information in a storage unit,
acquire operational information output from an information processing apparatus and a communication apparatus, normalize the operational information into structured information, and store the structured information in a storage unit,
refer to technical reference information stored in a storage unit,
analyze the operational information acquired and stored and the historical failure-response information recorded, detect a symptom of a failure, and generate structured incident information including at least operational information related to the symptom of the failure, candidate failure causes, past cases, and response results in the past cases,
generate a prompt sentence including a natural-language inquiry based on the incident information, input the prompt sentence into a generative artificial intelligence model, and cause the generative artificial intelligence model to generate proposal information in natural language regarding a failure cause and a countermeasure,
convert the proposal information generated by the generative artificial intelligence model into display information, present the display information to an external apparatus, and associate operation procedures included in the proposal information with executable processing targets, and acquire content of processing executed based on the presented proposal information and a success or failure result of the processing, record the acquired content and result in association as a failure-response result in the storage unit, and accumulate the failure-response result as learning data for updating processing content of the analysis of the operational information and the processing using the generative artificial intelligence model.

### (Supplementary 2)

The system according to supplementary 1,
wherein the processor is configured to
use the historical failure-response information recorded and the learning data accumulated as the failure-response result to learn occurrence patterns of failures and effectiveness of countermeasures, update weighting in estimation of the candidate failure causes and in generation of the incident information, and dynamically change elements and an ordering of description in the prompt sentence generated for the generative artificial intelligence model based on effectiveness of past proposal information.

### (Supplementary 3)

The system according to supplementary 1,
wherein the processor is configured to
add a safety condition and an output-format condition to the prompt sentence including the natural-language inquiry based on the incident information, prior to generation of the proposal information, and restrict response content of the generative artificial intelligence model so as to exclude, from the proposal information or output with a warning, operation instructions that violate the safety condition.

### Example 2

### (Supplementary 1)

A system comprising a processor,
wherein the processor is configured to
receive log information output from a communication apparatus, parse the log information by using pattern matching of character strings to extract time information, identification information, anomaly codes, and message bodies, normalize the extracted elements into structured data in a unified format, and supply the structured data to subsequent processing via a stream-processing infrastructure; and
store, in an information storage device, history information including occurrence times, target apparatuses, anomaly codes, estimated causes, executed procedures, required times, and results for past anomaly events, search the history information by using a query language, and, based on an anomaly code or an anomaly type included in the structured data, extract executed procedures and results of similar events and calculate statistical values, thereby functioning as a history search unit; and
store apparatus description documents in a document storage device in a form enabling full-text search, extract relevant descriptive portions from the apparatus description documents based on a search condition including the anomaly code or the anomaly type included in the structured data, and summarize, from the extracted portions, countermeasure procedures and cautions as snippet information, thereby functioning as a document reference unit; and acquire operation history including screen transition operations, selection operations, and retry operations on a display device, and acquire character input information and audio input information, calculate features including operation frequency, screen residence time, and re-display count from the operation history, apply an emotion classification model to the character input information and the audio input information to estimate emotion labels, and integrate the features and the emotion labels to determine an emotional state indicating a category of a psychological state of a user, thereby functioning as an emotion estimation unit; and
apply rule sets and a machine learning model to the structured data to calculate probability values for respective anomaly categories, and perform a weighted combination of a determination result of the rule sets and the probability values to determine a most probable anomaly cause candidate, thereby functioning as an anomaly analysis unit; and
receive, as inputs, the anomaly cause candidate, summary data of past events obtained by the history search unit, the snippet information obtained by the document reference unit, and the emotional state determined by the emotion estimation unit, select one template from among a plurality of templates in accordance with the emotional state, embed the anomaly cause candidate, the summary data of the past events, and the snippet information into predetermined positions in the selected template, and add instruction content including a format and a tone of an output to be generated, thereby generating a prompt sentence to be input to a generative AI model, and functioning as a prompt generation unit; and
input the prompt sentence generated by the prompt generation unit to the generative AI model, obtain a countermeasure procedure text in natural language, extract numbered steps, operation contents, execution examples, and warning statements from the countermeasure procedure text, and convert the extracted elements into structured data including step numbers, descriptions, execution commands, and risk information, thereby functioning as a countermeasure procedure generation unit; and
generate user interface data by using the structured data generated by the countermeasure procedure generation unit and the emotional state, select, in accordance with the psychological state of the user, one of a sequential display format and a list display format as a display mode, add warning display information in accordance with the risk information, and transmit the user interface data to a terminal device, thereby functioning as a presentation control unit; and
acquire, from the terminal device, information regarding execution results of respective steps, success or failure of anomaly handling, work time, user evaluations, and emotional states during handling, associate the information with the history information, record the associated information, and accumulate the associated information as learning data for the anomaly analysis unit and the emotion estimation unit, thereby functioning as a feedback recording unit.

### (Supplementary 2)

The system according to supplementary 1,
wherein the processor is configured to extract, as learning data, the history information and feedback information accumulated by the feedback recording unit, update parameters of an anomaly category classification model in the anomaly analysis unit and parameters of an emotion classification model in the emotion estimation unit by using a machine learning algorithm, and statistically analyze a relationship between prompt sentences generated by the prompt generation unit and user evaluations with respect to countermeasure procedures generated by the generative AI model based on the prompt sentences, thereby automatically adjusting wording and structure of the templates used by the prompt generation unit.

### (Supplementary 3)

The system according to supplementary 1,
wherein the processor is configured to, when the emotion estimation unit determines that the emotional state of the user is a high-stress and confused state, cause the prompt generation unit to select a template including detailed explanations and cautionary statements, generate a prompt sentence requesting the generative AI model to output, for each step, a purpose explanation, a specific operation example, and a prior warning for risky operations, and cause the presentation control unit to specify the sequential display format in which one step is presented on one screen, and to, when the emotion estimation unit determines that the emotional state of the user is a calm and confident state, cause the prompt generation unit to select a concise template limiting a number of steps, generate a prompt sentence requesting the generative AI model to list only main points, and cause the presentation control unit to specify the list display format in which a plurality of steps are displayed simultaneously, thereby dynamically switching the prompt sentence to the generative AI model and a presentation mode of the countermeasure procedures in accordance with the emotional state of the user.

### Application Example 2

### (Supplementary 1)

A system comprising a processor,
wherein the processor is configured to
record past failure-handling histories in a history storage unit, and
collect operation logs output from information processing equipment or communication equipment and structure the operation logs as time-series operation indicator data in a log collection unit, and
store technical document information in an information storage unit so as to be referable, and detect an abnormal event based on the operation logs, analyze log text related to the abnormal event by using at least one of natural language processing and machine learning, specify a failure type and a candidate failure cause, and extract a candidate countermeasure method based on the failure type, the candidate failure cause, the technical document information, and the past failure-handling histories in a failure analysis unit, and
calculate a user emotion state indicator in an emotion analysis unit by receiving as input at least one of text data, audio data, operation history data, and image data obtained from a user terminal and by applying at least one of natural language processing, acoustic signal processing, behavioral analysis, and image analysis, and
generate a prompt sentence for input to a generative AI model based on the failure type, the candidate failure cause, the candidate countermeasure method, the past failure-handling histories, and the user emotion state indicator, and input the prompt sentence to the generative AI model to obtain failure-handling procedure information in a prompt generation unit, and control display of the failure-handling procedure information in a display control unit by dynamically adjusting, according to the user emotion state indicator, a number of presentation steps, a level of detail of explanations, and a degree of use of technical terms and by outputting the failure-handling procedure information to the user terminal, and
store, as feedback information, operation results performed by the user in accordance with the failure-handling procedure information and changes in the user emotion state indicator, and update, in a learning unit, at least one of conditions for generating the prompt sentence and weighting of features in the emotion analysis unit based on the feedback information.

### (Supplementary 2)

The system according to supplementary 1,
wherein the processor is configured to
model, by using machine learning, a correspondence between the feedback information and at least one of the failure type and the user emotion state indicator, and automatically adjust, in the prompt generation unit, at least one of an upper limit of a number of steps in the prompt sentence, a level of detail of explanation text, and conditions for explaining technical terms based on a result of the modeling.

### (Supplementary 3)

The system according to supplementary 1,
wherein the processor is configured to
control, in the display control unit, when the user emotion state indicator indicates that a stress level is high and a comprehension level is low, display of only a currently executable step of the failure-handling procedure information in an emphasized manner while displaying remaining steps in a collapsed and simplified form and adding a term-interpretation display element to a technical term included in the failure-handling procedure information, and, when the user emotion state indicator indicates that the stress level is low and the comprehension level is high, switch a display format so that all steps are displayed in a list form together with detailed technical information.

What is claimed is:

1. A system comprising:
circuitry configured to:
receive, via a communication interface coupled to a packet-switched network, log data from one or more network devices, the log data including event messages with timestamps and severity indicators;
convert the log data into a unified format and store the converted log data in a storage device coupled to the packet-switched network;
classify an event indicated in the log data and estimate one or more candidate cause identifiers by comparing the converted log data against historical event records stored in the storage device using a machine learning classification model;
retrieve, from an indexed document data store, technical reference data associated with the one or more candidate cause identifiers;
construct a prompt data structure encoding the converted log data, the candidate cause identifiers, and the technical reference data, transmit the prompt data structure to a generative neural network model, and receive procedure data expressed in natural language from the generative neural network model; and
transmit the procedure data to a terminal device via the communication interface.

2. The system according to claim 1, wherein the log data comprises syslog protocol messages received from the one or more network devices, each syslog message including a facility code, a severity level, a hostname, and a message body, and wherein the circuitry parses the syslog messages to extract structured fields and converts the structured fields into the unified format.

3. The system according to claim 2, wherein the circuitry performs real-time filtering on the converted log data to identify event sequences matching predefined anomaly patterns, and generates an alert data structure when a matching event sequence is detected within a sliding time window.

4. The system according to claim 3, wherein the circuitry correlates the alert data structure with log data received from multiple network devices by matching timestamps and device identifiers to determine whether the detected anomaly pattern spans a plurality of network devices, and generates a correlated event record associating the related log entries.

5. The system according to claim 1, wherein the machine learning classification model comprises a neural network trained on the historical event records, each historical event record including event log data, a verified cause identifier, and a resolution outcome, and wherein the circuitry generates feature vectors from the converted log data and inputs the feature vectors to the machine learning classification model to obtain the one or more candidate cause identifiers with associated confidence scores.

6. The system according to claim 5, wherein the circuitry ranks the one or more candidate cause identifiers by the associated confidence scores and selects a top-ranked subset for inclusion in the prompt data structure.

7. The system according to claim 6, wherein the circuitry periodically retrains the machine learning classification model using newly accumulated historical event records stored in the storage device, including resolution outcomes received from the terminal device as feedback data.

8. The system according to claim 1, wherein the indexed document data store stores technical reference data derived from equipment specification documents, and wherein the circuitry retrieves the technical reference data by performing a semantic search using the candidate cause identifiers as query terms against an index of the document data store.

9. The system according to claim 8, wherein the prompt data structure includes a structured text sequence comprising a log summary section encoding the converted log data, a cause estimation section encoding the candidate cause identifiers with confidence scores, and a reference section encoding the retrieved technical reference data, and wherein the generative neural network model comprises a transformer-based architecture with a plurality of self-attention layers.

10. The system according to claim 9, wherein the procedure data received from the generative neural network model includes a stepwise sequence of actions, each action associated with a target device identifier and an expected outcome, and wherein the circuitry structures the procedure data into a formatted action plan data structure before transmitting to the terminal device.

11. The system according to claim 1, wherein the circuitry is further configured to receive, via the communication interface, evaluation data from the terminal device indicating at least one of an effectiveness rating of the procedure data and a verified cause identifier for the event, and to store the evaluation data together with the corresponding log data and procedure data as a new historical event record in the storage device.

12. The system according to claim 11, wherein the circuitry updates the prompt data structure construction based on the evaluation data by adjusting at least one of a weighting of the log summary section, the cause estimation section, and the reference section in the prompt data structure for subsequent events of a same classification category.

13. The system according to claim 1, wherein the circuitry monitors the converted log data over time using a time-series analysis model to detect degradation trends in device performance indicators, and generates a predictive alert data structure before an actual failure event occurs.

14. The system according to claim 13, wherein the circuitry constructs a preventive prompt data structure encoding the predictive alert data structure and transmits the preventive prompt data structure to the generative neural network model to receive preventive procedure data, and transmits the preventive procedure data to the terminal device as a proactive recommendation.

15. The system according to claim 1, wherein the circuitry is further configured to:
receive, via the communication interface, interaction log data from the terminal device; and
estimate a cognitive load state of an operator based on the interaction log data including response time patterns and navigation behavior.

16. The system according to claim 15, wherein the circuitry adjusts a level of detail of the procedure data transmitted to the terminal device based on the estimated cognitive load state, transmitting a condensed summary with critical actions when the cognitive load state exceeds a threshold and transmitting a detailed stepwise breakdown when the cognitive load state is below the threshold.

17. The system according to claim 16, wherein the circuitry further adjusts the prompt data structure based on the estimated cognitive load state to include a conciseness instruction when the cognitive load state exceeds the threshold, causing the generative neural network model to generate shorter procedure data.

18. A system comprising:
a communication interface including a network interface controller coupled to a packet-switched network and configured to transmit and receive data packets;
a memory storing instructions, a machine learning classification model trained on historical event records, a generative neural network model comprising a transformer architecture with a plurality of self-attention layers, and an indexed document data store containing technical reference data; and
circuitry comprising one or more processors coupled to the memory and configured to execute the instructions to:
receive, via the communication interface, log data from one or more network devices, convert the log data into a unified format, and store the converted log data in a storage device;
classify an event indicated in the converted log data and estimate candidate cause identifiers with associated confidence scores using the machine learning classification model;
retrieve technical reference data from the indexed document data store by performing a semantic search using the candidate cause identifiers;
construct a prompt data structure encoding the converted log data, the candidate cause identifiers, and the technical reference data, and transmit the prompt data structure to the generative neural network model to receive procedure data;
transmit the procedure data to a terminal device via the communication interface; and
receive evaluation data from the terminal device and store the evaluation data as a new historical event record for retraining the machine learning classification model.

19. The system according to claim 18, wherein the circuitry is further configured to estimate a cognitive load state of an operator based on interaction log data received from the terminal device, and to adjust a level of detail of the procedure data based on the estimated cognitive load state.

20. A method performed by circuitry of a server coupled to a packet-switched network via a communication interface, the method comprising:
receiving, via the communication interface, log data from one or more network devices, the log data including event messages with timestamps and severity indicators;
converting the log data into a unified format and storing the converted log data in a storage device coupled to the packet-switched network;
classifying an event indicated in the log data and estimating one or more candidate cause identifiers by comparing the converted log data against historical event records stored in the storage device using a machine learning classification model;
retrieving, from an indexed document data store, technical reference data associated with the one or more candidate cause identifiers;
constructing a prompt data structure encoding the converted log data, the candidate cause identifiers, and the technical reference data, transmitting the prompt data structure to a generative neural network model, and receiving procedure data expressed in natural language from the generative neural network model; and
transmitting the procedure data to a terminal device via the communication interface.
